(19) United States
(12) Patent Application Publication
(10) Pub. No.: US 2017/0064718 A1
(43) Pub. Date: Mar. 2, 2017

(54) RESOURCE ALLOCATION SIGNALING IN A WIRELESS LOCAL AREA NETWORK PREAMBLE

(71) Applicant: QUALCOMM Incorporated, San Diego, CA (US)

(72) Inventors: Arjun Bharadwaj, Poway, CA (US); Bin Tian, San Diego, CA (US); Sameer Vermani, San Diego, CA (US)

(21) Appl. No.: 15/245,153

(22) Filed: Aug. 23, 2016

Related U.S. Application Data
(60) Provisional application No. 62/209,868, filed on Aug. 25, 2015.

(51) Int. Cl. H04W 72/04; H04W 28/08; H04B 7/04

(52) U.S. Cl. CPC H04W 72/0493; H04B 7/0452; H04W 28/08; H04W 72/0486; H04W 84/12

(57) ABSTRACT

Resource allocation signaling in a high efficiency wireless local area network (WLAN) is disclosed. An access point (AP) may generate a resource unit (RU) size indicator in a first WLAN signaling field, the RU size indicator decodable by a set of stations. The AP may also generate a common user field in a second WLAN signaling field, such that a size of the common user field may be based on the RU size indicator of the first WLAN signaling field. The AP may generate a station-specific field in the second WLAN signaling field, such that a position of the a station-specific field corresponds to one or more RUs associated with the a station-specific field. The AP may then transmit a WLAN preamble that includes the first WLAN signaling field followed by the second WLAN signaling field.

### CROSS REFERENCES

The present application for patent claims priority to U.S. Provisional Patent Application No. 62/209,868 by Bharadwaj, et al., entitled “Resource Allocation Signaling In A High Efficiency wireless Local Area Network Preamble,” filed Aug. 25, 2015, assigned to the assignee hereof, and expressly incorporated by reference herein.

### BACKGROUND

The present disclosure, for example, relates to wireless communication systems, and more particularly to techniques for resource allocation signaling in a high efficiency wireless local area network (WLAN) preamble.

Wireless communications systems are widely deployed to provide various types of communication content such as voice, video, packet data, messaging, broadcast, and so on. These systems can be multiple-access systems capable of supporting communication with multiple users by sharing the available system resources (e.g., time, frequency, and power). A wireless network (e.g., a WLAN, such as a Wi-Fi network conforming to one or more of the IEEE 802.11 family of standards) oftentimes includes an access point (AP) that communicates with one or more stations (STAs) or mobile devices. The AP can oftentimes be coupled to a network, such as the Internet, and may enable a station or mobile device to communicate via the network (and/or communicate with other devices coupled to the AP).

An allocation of resources for a wireless communication can be indicated within a WLAN preamble. Different resource allocation schemes may be used to efficiently use resources and to reduce signaling complexity.

### SUMMARY

Methods, apparatuses, and computer readable media for resource allocation signaling in a high efficiency wireless local area network (WLAN) are disclosed. An access point (AP) may generate a resource unit (RU) size indicator in a first WLAN signaling field, the RU size indicator decodable by a set of stations. The AP may also generate a common user field in a second WLAN signaling field, such that a size of the common user field may be based on the RU size indicator of the first WLAN signaling field. The RU size indicator, which may be a plurality of bits, may indicate a number or tones in an RU, or a bandwidth of the common user field, or a number of user devices, or some combination of these parameters. An RU allocation plan may be in a multi-user (MU) physical layer protocol data unit (PPDU) (MU-PPDU), and RU size indicator indicating that such RU allocation plan may be associated with a multi-user multi-input multi-output (MU-MIMO) transmission, or an orthogonal frequency division multiple access (OFDMA) single-user transmission, or both. The size of the common user field may be based on the bandwidth associated with the common user field and the RU size indicator. The total bandwidth for the stations may also be split into one or more portions for independent RU allocation. The size of one or more of the common user fields may then be determined based on the RU size for one or more the split portions.

The AP may generate a station-specific field in the second WLAN signaling field, such that a position of the station-specific field corresponds to one or more RUs associated with the a station-specific field. The AP may then transmit a WLAN preamble that includes the first WLAN signaling field, followed by the second WLAN signaling field.

One or more stations (e.g., wireless or mobile devices) may receive the WLAN preamble, including both the first and second WLAN signaling fields. The stations may then determine the size of the common user field expected by the station based at least in part on an RU size indicator that the station identifies in the first WLAN signaling field. Using in part the expected sized of the common user field, the station may then identify the common user field in the second WLAN signaling field.

In some examples, load balancing may also be used for various of the channels to more evenly distribute RUs, and a load balancing indicator in the first WLAN signaling field used to indicate that an order of bits in the common user field have been remapped according to the load balancing. The AP may perform load balancing and insert the load balancing indicator in the first WLAN signaling field, and a receiving station may identify the load balancing indicator to detect that load balancing has been used after receipt of the preamble.

A device may also signal a resource allocation scheme in a high efficiency WLAN preamble. In one example, a high efficiency (HE) WLAN signaling field is used to signal a resource allocation pattern to multiple devices. The HE WLAN signaling field includes a common user field that is decodable by the multiple devices and includes a resource allocation field. The resource allocation indicates resource unit distributions to the multiple devices and indicates which resource units in in a multi-user physical (PHY) layer protocol data unit (PPDU) correspond to multi-user (MU) multiple input multiple output (MIMO) (MU-MIMO) transmissions and which resource units correspond to orthogonal frequency division multiple access (OFDMA) single-user transmissions. The HE WLAN signaling field also includes dedicated user fields that are assigned to certain devices. The order of the dedicated user fields corresponds to the allocated resource units. The HE WLAN signaling field is transmitted with a WLAN preamble to the multiple devices.

A method of wireless communication at an access point is described. The method may include generating an RU size indicator in a first WLAN signaling field, a common user field in a second WLAN signaling field, and at least one station-specific field in the second WLAN signaling field, wherein the RU size indicator and the common user field are decodable by a plurality of stations, wherein a size of the common user field is based at least in part on the RU size indicator, and wherein the at least one station-specific field corresponds to one or more RUs associated with the at least one station-specific field; and transmitting a WLAN preamble that includes the first WLAN signaling field followed by the second WLAN signaling field.

A second method of wireless communication at a station (STA) is described. The method may include receiving a WLAN preamble that may include a first WLAN signaling field followed by a second WLAN signaling field, identifying an RU size indicator in the first WLAN signaling field, determining an expected size of a common user field based at least in part on the RU size indicator, and identifying the common user field in the second WLAN signaling field based at least in part on the expected size of the common user field.

An apparatus for wireless communication is described. The apparatus may be an access point and include means for generating an RU size indicator in a first WLAN signaling field, the RU size indicator decodable by multiple stations, means for generating a common user field in a second WLAN signaling field, where a size of the common user field is based at least in part on the RU size indicator of the first WLAN signaling field, the common user field decodable by multiple stations, means for generating at least one station-specific field in the second WLAN signaling field, where the at least one station-specific field corresponds to one or more RUs associated with the at least one station-specific field, and means for transmitting a WLAN preamble that includes the first WLAN signaling field followed by the second WLAN signaling field.

A further apparatus for wireless communication is described. The apparatus may be an access point including a processor, memory in electronic communication with the processor, and instructions stored in the memory and operable, when executed by the processor, to cause the apparatus to generate an RU size indicator in a first WLAN signaling field, the RU size indicator decodable by multiple stations, generate a common user field in a second WLAN signaling field, where a size of the common user field is based at least in part on the RU size indicator of the first WLAN signaling field, the common user field decodable by the multiple stations, generate at least one station-specific field in the second WLAN signaling field, where the at least one station-specific field corresponds to one or more RUs associated with the at least one station-specific field, and transmit a WLAN preamble that includes the first WLAN signaling field followed by the second WLAN signaling field.

Another further apparatus for wireless communication is described. The apparatus may be a STA and may include means for receiving a WLAN preamble that may include a first WLAN signaling field followed by a second WLAN signaling field, means for identifying an RU size indicator in the first WLAN signaling field, means for determining an expected size of a common user field based at least in part on the RU size indicator, and means for identifying the common user field in the second WLAN signaling field based at least in part on the expected size of the common user field.

Another further apparatus for wireless communication is described. The apparatus may be a STA and include a processor, memory in electronic communication with the processor, and instructions stored in the memory and operable, when executed by the processor, to cause the apparatus to receive a WLAN preamble that may include a first WLAN signaling field followed by a second WLAN signaling field, identify an RU size indicator in the first WLAN signaling field, determine an expected size of a common user field based at least in part on the RU size indicator, and identify the common user field in the second WLAN signaling field based at least in part on the expected size of the common user field.

A non-transitory computer-readable medium storing code for wireless communication at an access point is described. The code may include instructions executable to generate an RU size indicator in a first WLAN signaling field, the RU size indicator decodable by multiple stations, generate a common user field in a second WLAN signaling field, where a size of the common user field is based at least in part on the RU size indicator of the first WLAN signaling field, the common user field decodable by the multiple stations, generate at least one station-specific field in the second WLAN signaling field, where the at least one station-specific field corresponds to one or more RUs associated with the at least one station-specific field, and transmit a WLAN preamble that includes the first WLAN signaling field followed by the second WLAN signaling field.

A further non-transitory computer-readable medium storing code for wireless communication at a STA is described. The code may include instructions executable to receive a WLAN preamble that may include a first WLAN signaling field followed by a second WLAN signaling field, identify an RU size indicator in the first WLAN signaling field, determine an expected size of a common user field based at least in part on the RU size indicator, and identify the common user field in the second WLAN signaling field based at least in part on the expected size of the common user field.

Some examples of the method, apparatuses, or non-transitory computer-readable medium described herein may further include processes, features, means, or instructions for determining the size of the common user field based at least in part on a bandwidth associated with the common user field and the RU size indicator, where the RU size indicator indicates a parameter selected from a group consisting of a number of tones in a RU, a bandwidth of the common user field, and a number of user devices. Additionally or alternatively, some examples may include processes, features, means, or instructions for determining the size of the common user field based at least in part on a bandwidth associated with the common user field and the RU size indicator, where the RU size indicator indicates that one or more RU allocation plans in an MU-PPDU are associated with an MU-MIMO transmission or an OFDMA single-user transmission.

In some examples of the method, apparatuses, or non-transitory computer-readable medium described herein, the at least one station-specific field may include a first station-specific field and a second station-specific field, the one or more RUs may include a first RU associated with the first station-specific field and a second RU associated with the second station-specific field, and generating the at least one station-specific field may include determining a position of the first station-specific field with respect to a position of the second station-specific field based at least in part on a position of the first RU with respect to the second RU. In some examples of the method, apparatuses, or non-transitory computer-readable medium described herein, the RU size indicator may include a plurality of bits, and some examples may include processes, features, means, or instructions for splitting a total bandwidth for the multiple stations into multiple portions for independent RU allocation, and determining the size of the common user field based at least in part on the multiple bits and an RU size associated with at least one of the portions.

For some examples of the method, apparatuses, or non-transitory computer-readable medium described herein, the RU size indicator includes multiple bits that may indicate that the one or more RUs associated with the at least one station-specific field are associated with an MU-MIMO transmission or an OFDMA single-user transmission or a combination of MU-MIMO and OFDMA transmissions, and an RU allocation plan may depend at least in part on the multiple bits. Additionally or alternatively, some examples may include processes, features, means, or instructions for generating a load balancing indicator in the first WLAN signaling field, where the load balancing indicator indicates a remapping of an order of bits in the common user field.

Some examples of the method, apparatuses, or non-transitory computer-readable medium described herein may further include processes, features, means, or instructions for identifying that the one or more RUs are associated with a MU-MIMO transmission, mapping a first RU allocation plan associated with a first one or more user devices to a first channel, and mapping a second RU allocation plan associated with a second one or more user devices to a second channel. Additionally or alternatively, in some examples a difference between a count of the first one or more user devices is one or fewer than a count of the second one or more user devices.

In some examples of the method, apparatuses, or non-transitory computer-readable medium described herein, the common user field may include a resource allocation field indicating one or more communication resource units in an MU-PPDU, the first WLAN signaling field may include a high efficiency signaling A (HE-SIG-A) field, and the second WLAN signaling field may include a high efficiency signaling B (HE-SIG-B) field.

In some examples of the method, apparatuses, or non-transitory computer-readable medium described herein, the RU size indicator indicates that one or more RU allocation plans in an MU-PPDU are associated with an MU-MIMO transmission or an orthogonal frequency division multiple access (OFDMA) single-user transmission.

In some examples of the method, apparatuses, or non-transitory computer-readable medium described herein, the RU size indicator comprises a plurality of bits that indicate that the one or more RUs associated with the at least one station-specific field are associated with an MU-MIMO transmission or an OFDMA single-user transmission or a combination of MU MIMO and OFDMA transmissions.

Some examples of the method, apparatuses, or non-transitory computer-readable medium described herein may further include processes, features, means, or instructions for identifying a load balancing indicator in the first WLAN signaling field and determining an order of bits in the common user field based at least in part on the identified load balancing indicator.

Some examples of the method, apparatuses, or non-transitory computer-readable medium described herein may further include processes, features, means, or instructions for determining that the RU size indicator indicates an MU-MIMO allocation that spans a total bandwidth, and identifying the size of the common user field to be zero based at least in part on determining that the RU size indicator indicates the MU-MIMO allocation spans the total bandwidth.

Some examples of the methods, apparatuses, or non-transitory computer-readable media described herein may further include processes, features, means, or instructions for resource allocation signaling in a high efficiency WLAN preamble. Further scope of the applicability of the described systems, methods, apparatuses, or computer-readable media will become apparent from the following detailed description, claims, and drawings. The detailed description and specific examples are given by way of illustration only, since various changes and modifications within the scope of the description will become apparent to those skilled in the art.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 illustrates an example of a wireless communications system that supports resource allocation signaling in a high efficiency wireless local area network (WLAN) preamble in accordance with various aspects of the present disclosure;

FIG. 2 shows an example of a WLAN protocol data unit (PDU) (e.g., a physical layer convergence PDU (PPDU)) resource allocation signaling in a high efficiency WLAN preamble in accordance with various aspects of the present disclosure;

FIG. 3 illustrates an example of aspects of a WLAN protocol data unit for resource allocation signaling in a high efficiency WLAN preamble in accordance with various aspects of the present disclosure;

FIG. 4 illustrates an example of aspects of a WLAN protocol data unit for resource allocation signaling in a high efficiency WLAN preamble in accordance with various aspects of the present disclosure;

FIGS. 5A-5F illustrate examples of resource allocation schemes for resource allocation signaling in a high efficiency WLAN preamble in accordance with various aspects of the present disclosure;

FIGS. 6A and 6B illustrate examples of common and dedicated block signaling for a high efficiency signaling B (HE-SIG-B) field that supports resource allocation signaling in a high efficiency WLAN preamble in accordance with aspects of the present invention;

FIG. 7 illustrates an example of a resource allocation scheme that supports resource allocation signaling in a high efficiency WLAN preamble in accordance with aspects of the present invention;

FIGS. 8 and 9 illustrate examples of an HE-SIG-B field that supports resource allocation signaling in a high efficiency WLAN preamble in accordance with aspects of the present invention;

FIGS. 10 and 11 show flow charts that illustrate examples of methods for wireless communication, in accordance with various aspects of the present disclosure;

FIGS. 12A-12B show an examples of an encoding structure in accordance with various aspects of the present disclosure;

FIG. 13 illustrates an example of a transmission structure for a second WLAN signaling block in accordance with various aspects of the present disclosure;

FIGS. 14A-14B illustrate examples of a common block field size table for in accordance with various aspects of the present disclosure;

FIGS. 15A-15C illustrates examples of a second WLAN signaling field in accordance with various aspects of the present disclosure;

FIG. 16 illustrates an example of a second WLAN signaling field for a PPDU having a bandwidth of 80 MHz in accordance with various aspects of the present disclosure;

FIG. 17A illustrates an example of a common block field size for differing bandwidth sizes in accordance with various aspects of the present disclosure;

FIG. 17B illustrates an example of common block field size for a fixed number of tones in a RU size in accordance with various aspects of the present disclosure;

FIG. 18 illustrates an example of a common block field size in accordance with various aspects of the present disclosure;

FIG. 19A illustrates an example of an RU allocation mapping in accordance with various aspects of the present disclosure;

FIG. 19B illustrates an example of an RU allocation mapping in accordance with various aspects of the present disclosure;

FIG. 20 illustrates an example of load balancing in accordance with various aspects of the present disclosure;

FIG. 21 illustrates an example of load balancing in accordance with various aspects of the present disclosure;

FIGS. 22A and 22B show block diagrams of an example wireless device that supports resource allocation signaling in an HE WLAN preamble in accordance with various aspects of the present disclosure;

FIG. 23 shows a flow chart that illustrates one example of a method for wireless communication, in accordance with various aspects of the present disclosure; and

FIGS. 24-25 illustrate methods for resource allocation signaling in a high efficiency WLAN preamble in accordance with various aspects of the present disclosure.

### DETAILED DESCRIPTION

A wireless local area network (WLAN) signaling field, for example a high efficiency (HE) signaling field B (HE-SIG-B), may be included in a preamble for multiuser (MU) transmissions. The WLAN signaling field may provide resource allocation information such that each scheduled station (STA) may decode data in an appropriate resource unit (RU). Different resource allocation schemes within the WLAN signaling field may be used to efficiently use resources and to reduce signaling complexity.

According to the present disclosure, a device may signal a resource allocation scheme in a HE WLAN preamble. In one example, an HE WLAN signaling field may be used to signal a resource allocation pattern to multiple devices. The HE WLAN signaling field includes a common user field that is decodable by the multiple devices and includes a resource allocation field. In other examples, a common station field may be included in the HE WLAN signaling field, the common station field decodable by one or more stations. In the examples described herein, a common user field may be a common station field. The resource allocation field indicates resource unit distributions to the multiple devices and indicates which resource units in an MU-PPDU correspond to MU-MIMO transmissions and which resource units correspond to OFDMA single-user transmissions. The HE WLAN signaling field also includes dedicated user fields that are assigned to certain devices. The order of the dedicated user fields corresponds to the allocated resource units. The HE WLAN signaling field is transmitted with a WLAN preamble to the multiple devices.

In one example, a resource allocation field, located in the common field of the HE WLAN signaling field, includes indicators that specify a transmission type (e.g., OFDMA single-user, MU-MIMO, wideband, narrowband), a resource allocation pattern, and/or the number of users assigned to a resource unit allocation. The resource allocation field includes indices that complement the indicators to signal different resource allocation patterns, different resource allocation sizes, and/or the number of users associated with a resource allocation pattern. The resource allocation field is partitioned into a first and a second portion. In one example, the first portion is associated with and provides resource allocation information for the first portion of a channel and the second portion is associated with and provides resource allocation information for the second portion of the channel. In another example, only the first portion is used (e.g., to signal OFDMA single-user wideband transmissions). In yet another example, the first portion and the second portion are complementary and indicate the number of users associated with an MU-MIMO transmission.

In another example, the resource allocation field includes an allocation plan field and a first MU field and a second MU field. The allocation plan field is used to indicate the different resource allocation patterns that may be designated by the resource allocation field. The first MU field and the second MU field are used to designate the number of users associated with a resource allocation pattern for MU-MIMO transmissions. In one example, the first MU field corresponds to the first portion of a channel and the second MU field corresponds to the second portion of a channel (e.g., for MU resource unit allocations that are less than 20 MHz). In another example, the first and second MU fields are not used (e.g., in the case of an OFDMA single-user transmission). In yet another example, only the first MU portion is used to designate the number of users (e.g., for a wideband MU transmission).

The dedicated user blocks that are subsequent to the common field indicate to a device which resource allocation units are assigned to that device. In one example, the order by which the dedicated user blocks are generated after the common block corresponds to a resource unit. In this way, a device determines when a dedicated user block was received (e.g., the first user block) and identifies the corresponding allocated resource unit (e.g., the first resource unit) as being assigned to the device. The dedicated user block includes a station identification field to assign the dedicated user block to a device and additional control information associated with the upcoming transmission.

In other aspects of the disclosure one or more indicators in a first HE WLAN signaling field may be used to determine a feature of a common user field in a second HE WLAN signaling field. In one example, an RU size indicator in a high efficiency signaling A (HE-SIG-A) field may be used to determine a feature of a common user field in a high efficiency signaling B (HE-SIG-B) field. The HE-SIG-B field may be part of a WLAN preamble for MU transmissions. These MU transmissions may be, for example, OFDMA transmissions, or MU-MIMO transmissions, or other MU transmissions.

Various control information may be included in the HE-SIG-B field, such as information to specify a modulation and coding scheme (MCS), coding, spatial multiplexing or other information that may be used by a receiver to decode data sent in the WLAN frame. The HE-SIG-B field may also include resource allocation information so that each STA scheduled to receive a MU transmission has information concerning which portions of the data to decode, e.g. which RU or RUs are meant to be decoded by that particular STA.

The HE-SIG-B field may include a common portion (one or more common user fields) and a dedicated portion (one or more dedicated user fields). The common user field may be decodable by multiple STAs. As further described below, the common user field may include multiple sub-bands, for example supporting multiple streams. A device that receives a user block within a frequency band associated with a stream may also receive data within the same frequency band. The common and dedicated content (e.g. the information in common block fields, and user blocks dedicated block field) for every other 20 MHz channel may be signaled together.

In certain implementations, a 20 MHz channel bandwidth may be used, and HE-SIG-B information sent in duplicate on every other channel. For a PPDU having a bandwidth of 20 MHz or 80 MHz, a size of a common block field transmitted in the second WLAN signaling field may be eight (8) bits. Where the bandwidth of a PPDU is 80 MHz, 160 MHz, or larger, the size of a common block field transmitted in the second WLAN signaling field may be 16 bits, 32 bits, or more, respectively. Because the common block field may be transmitted for every other channel with each channel with which it is associated, the common block field may inefficiently grow in size for a PPDU having a large bandwidth allocation, especially where the number of users is low. For example, for two users sharing a large bandwidth, such as 160 MHz, where the common block field may be 32 bits, up to 24 bits may be redundant. Such situations may occur frequently where small numbers of users are accessing an AP.

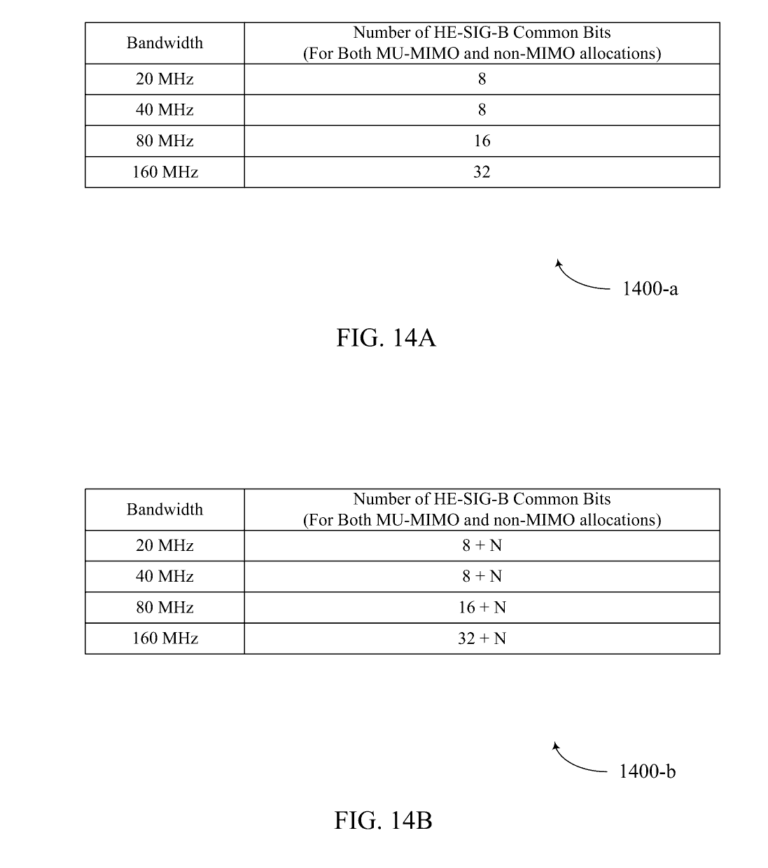

In some examples a number of bits, in addition to the common block bits used to identify how a data field is partitioned amongst devices (e.g. partitioning of the data field into RUs), in the common block field, an additional N bits may be provided in the common block field. These N bits may be common to all users in the PPDU, or common to all users in a 20 MHz channel. These bits may not be a part of a resource allocation field of the common block field, but may be used to convey other types of information, for example bits indicating padding or packet extension, legacy training field (LTF), compression indication, number of LTFs in the PPDU, etc. The N bits may also contain information to decode the common portion. Where additional N bits are provided, the common portion size (size of the common block field) is of size 8+N, 16+N, and 32+N, etc. This is illustrated in common block field size table 1400-b in FIG. 14B.

Including an RU size indicator in the first WLAN signaling field at the access point may indicate to the receiving station that a different size of the common block field is being used, so that a transmitted PPDU may be successfully decoded by the station. Bits indicating the bandwidth (BW) over which the PPDU is being transmitted is already included in the first WLAN signaling field (e.g. an HE-SIG-A field), so that the receiving station has this information, and may use the RU size indicator in combination with the indicated bandwidth to determine what is the size of the common block field in the transmitted PPDU frame and what is the minimum RU size to be allocated (e.g. 242 tones, 484 tones, etc.). In an example, the size of the common block field may be fixed to a certain size according to a presence of an RU size indicator, so that for a given bandwidth, the RU size may be different to maintain the fixed common block field size. In another example, minimum RU size may be fixed, so that the size of the common block field may be different based on the presence of the RU size indicator in the first WLAN signaling field.

The RU size indicator may be a single bit as described above, or may also be two or more bits to provide greater flexibility. For example, the two bits may determine a minimum RU size and corresponding size of a common block field for a given PPDU bandwidth. In another example, the two bits may determine a channel allocation between MU-MIMO and OFDMA, where MU-MIMO may be used for one channel and OFDMA for a second channel, or combinations thereof, to modify an RU allocation plan.

In some examples, the AP may generate a resource unit (RU) size indicator in a first wireless local area network (WLAN) signaling field, the RU size indicator decodable by a set of stations.

In some examples, the AP may generate a common user field in a second WLAN signaling field, such that a size of the common user field may be based on the RU size indicator of the first WLAN signaling field, the common user field decodable by the set of stations.

The AP may generate, subsequent to the common user field in the second WLAN signaling field, a station-specific field, such that a position of the a station-specific field corresponds to one or more RUs associated with the a station-specific field.

In some examples, the AP may transmit a WLAN preamble that includes the first WLAN signaling field followed by the second WLAN signaling field.

In some examples, the AP may determine the size of the common user field based on a bandwidth associated with the common user field and the RU size indicator, such that the RU size indicator indicates a parameter selected from a group consisting of a number of tones in a RU, a bandwidth of the common user field, and a number of user devices. For example, RU size indicator may indicate the number of user devices associated with a MU-MIMO allocation when the total bandwidth is used for a single MU-MIMO allocation.

In some cases, the AP may determine the size of the common user field based on a bandwidth associated with the common user field and the RU size indicator, such that the RU size indicator indicates that one or more RU allocation plans in a MU physical layer protocol data unit (PPDU) (MU-PPDU) are associated with an multi-user multi-input multi-output (MU-MIMO) transmission or an OFDMA single-user transmission. In some examples the RU size indicator may include multiple bits. In some examples, the RU size indicator in the first WLAN signaling field may indicate that the entire bandwidth is to be allocated for a single MU-MIMO transmission. In this example, a size of the HE-SIG-B field of a WLAN preamble may be reduced, and the common user field may have a size of zero. The common user field having a size of zero may mean that the common user field is absent from the WLAN preamble. A station receiving the WLAN preamble without a common user field may determine (e.g., implicitly) that the common user field is not present by identifying that the RU size indicator indicates that the entire bandwidth is allocated for the single MU-MIMO transmission.

In some examples, the AP may split a total bandwidth for the set of stations into a set of portions for independent RU allocation.

In some examples, the AP may determine the size of the common user field based on the set of bits and an RU size associated with a of the portions.

In some cases, number of bits may indicate that the one or more RUs associated with the at least one station-specific field may be associated with an MU-MIMO transmission or an OFDMA single-user transmission or a combination of MU-MIMO and OFDMA transmissions. In some examples an RU allocation plan may depend on the number of bits.

In some examples, the AP may generate a load balancing indicator in the first WLAN signaling field, such that the load balancing indicator indicates a remapping of an order of bits in the common user field.

In some examples, the AP may identify that the one or more RUs are associated with a MU-MIMO transmission.

In some examples, the AP may map a first RU allocation plan associated with a first one or more user devices to a first channel.

In some examples, the AP may map a second RU allocation plan associated with a second one or more user devices to a second channel. In some examples a difference between a count of the first one or more user devices is one or fewer than a count of the second one or more user devices. In other examples a difference between a count of the first one or more user devices is more than a count of the second one or more user devices. In some examples the common user field may include a resource allocation field indicating one or more communication resource units in an MU-PPDU, where the first WLAN signaling field comprises a high efficiency signaling A (HE-SIG-A) field, and the second WLAN signaling field comprises a high efficiency signaling B (HE-SIG-B) field.

In some examples the STA may receive a WLAN preamble that includes a first WLAN signaling field followed by a second WLAN signaling field. In some examples the STA may identify an RU size indicator in the first WLAN signaling field. In some examples the STA may determine an expected size of a common user field based on the RU size indicator. In some examples the STA may identify the common user field in the second WLAN signaling field based on the expected size of the common user field.

These and other aspects of the disclosure are further illustrated by and described with reference to apparatus diagrams, system diagrams, and flowcharts.

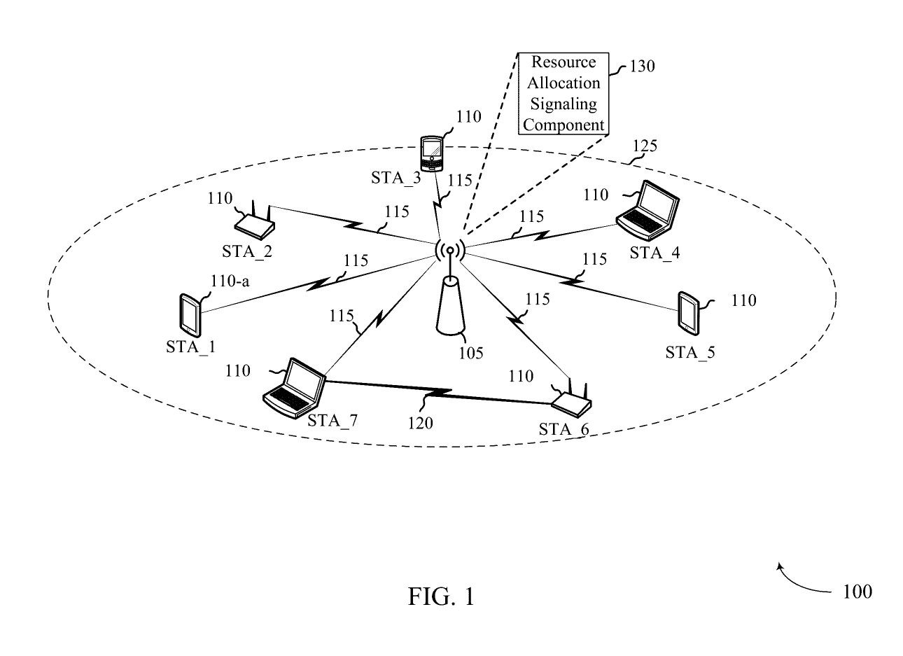

FIG. 1 illustrates an example of a wireless local area network (WLAN) 100 that supports resource allocation signaling in an WLAN preamble (e.g., a HE WLAN preamble) in accordance with various aspects of the present disclosure.

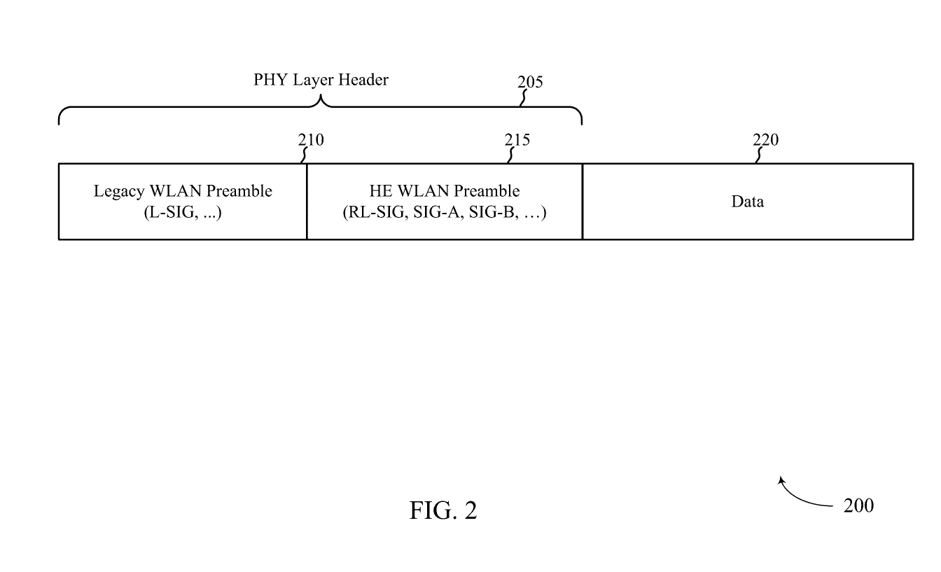

The WLAN 100 includes an access point (AP) 105 and stations (STAs) 110 labeled as STA_1 through STA_7. The STAs 110 may represent devices such as wireless communication terminals, including mobile stations, phones, personal digital assistant (PDAs), other handheld devices, netbooks, notebook computers, tablet computers, laptops, display devices (e.g., TVs, computer monitors, etc.), printers, etc. While only one AP 105 is illustrated, the WLAN 100 can have multiple APs 105. STAs 110, can also be referred to as a mobile stations (MS), mobile devices, access terminals (ATs), user equipment (UEs), subscriber stations (SSs), or subscriber units. The STAs 110 associate and communicate with the AP 105 via a communication link 115. Each AP 105 has a coverage area 125 such that STAs 110 within that area are within range of the AP 105. The STAs 110 are dispersed throughout the coverage area 125. Each STA 110 is stationary, mobile, or a combination thereof. Devices in WLAN 100 may communicate over unlicensed spectrum, which may be a portion of spectrum that includes frequency bands traditionally used by Wi-Fi technology, such as the 5 GHz band, the 2.4 GHz band, the 60 GHz band, the 3.6 GHz band, and/or the 900 MHz band. The unlicensed spectrum may also include other frequency bands. One or more of the STAs 110 and/or APs 105 may comprise a resource allocation signaling component 130, which may enable the STAs 110 and/or the APs 105 to signal resource allocations in a WLAN preamble, for example as further discussed below with reference to FIGS. 2-25.

Although not shown in FIG. 1, a STA 110 can be covered by more than one AP 105 and can therefore associate with multiple APs 105 at different times. A single AP 105 and an associated set of STAs 110 is referred to as a basic service set (BSS). An extended service set (ESS) is a set of connected BSSs. A distribution system (DS) is used to connect APs 105 in an extended service set. A coverage area 125 for an AP 105 can be divided into sectors making up only a portion of the coverage area. The WLAN 100 includes APs 105 of different types (e.g., metropolitan area, home network, etc.), with varying sizes of coverage areas and overlapping coverage areas for different technologies. Although not shown, other devices can communicate with the AP 105.

While the STAs 110 are capable of communicating with each other through the AP 105 using communication links 115, STAs 110 can also communicate directly with each other via direct wireless communication links 120. Direct wireless communication links can occur between STAs 110 regardless of whether any of the STAs is connected to an AP 105. Examples of direct wireless communication links 120 include Wi-Fi Direct connections, connections established by using a Wi-Fi Tunneled Direct Link Setup (TDLS) link, and other peer-to-peer (P2P) group connections.

The STAs 110 and APs 105 shown in FIG. 1 communicate according to the WLAN radio and baseband protocol including physical (PHY) and medium access control (MAC) layers from IEEE 802.11, and its various versions including, but not limited to, 802.11b, 802.11g, 802.11a, 802.11n, 802.11ac, 802.11ad, 802.11ah, 802.11z, 802.11ax, etc.

Transmissions to/from STAs 110 and APs 105 oftentimes include control information within a header that is transmitted prior to data transmissions. The information provided in a header is used by a device to decoded the subsequent data. High efficiency WLAN preambles can be used to schedule multiple devices, such as STAs 110, for single-user simultaneous transmission (e.g., single-user orthogonal frequency division multiple access (SU-OFDMA)) and/or MU-MIMO transmissions. In one example, an HE WLAN signaling field may be used to signal a resource allocation pattern to multiple receiving STAs 110. The HE WLAN signaling field includes a common user field that is decodable by multiple STAs 110, the common user field including a resource allocation field. The resource allocation field indicates resource unit distributions to the multiple STAs 110 and indicates which resource units in a resource unit distribution correspond to MU-MIMO transmissions and which resource units correspond to OFDMA single-user transmissions. The HE WLAN signaling field also includes, subsequent to the common user field, dedicated user fields that are assigned to certain STAs 110. The order in which the dedicated user fields are generated corresponds to the allocated resource units (e.g., the first dedicated user field corresponds to the first allocated resource unit). The HE WLAN signaling field is transmitted with a WLAN preamble to the multiple STAs 110.

FIG. 2 shows an example of a WLAN protocol data unit (PDU) 200 (e.g., a physical layer convergence PDU (PPDU)) resource allocation signaling in a high efficiency WLAN preamble in accordance with various aspects of the present disclosure. WLAN PDU 200 illustrates aspects of a transmission between a STA 110 and an AP 105, as described above with reference to FIG. 1.

In this example, the WLAN PDU 200 may include a PHY layer header 205 and a data field 220 (e.g., a MAC protocol data unit (MPDU) or physical layer service data unit (PSDU)). The PHY layer header 205 may include a legacy WLAN preamble 210 and a high efficiency WLAN preamble 215. The preambles and data field may be transmitted in the following order: legacy WLAN preamble 210, high efficiency WLAN preamble 215, data field 220.

The WLAN PDU 200 may be transmitted over a radio frequency spectrum band, which in some examples may include multiple sub-bands. In some examples, the radio frequency spectrum band may have a bandwidth of 80 MHz, and each of the sub-bands may have a bandwidth of 20 MHz. The legacy WLAN preamble 210 may include legacy short training field (STF) (L-STF) information, legacy long training field (LTF) (L-LTF) information, and legacy signaling (L-SIG) information. When the radio frequency spectrum band includes multiple sub-bands, the L-STF, L-LTF, and L-SIG information may be duplicated and transmitted in each of the multiple sub-bands. The legacy preamble may be used for packet detection, automatic gain control, channel estimation, etc. The legacy preamble may also be used to maintain compatibility with legacy devices.

The high efficiency WLAN preamble 215 may include any of a repeated legacy WLAN field (e.g., an RL-SIG field), a first WLAN signaling field (e.g., a first high efficiency WLAN signaling field such as HE-SIG-A), a second WLAN signaling field (e.g., a second high efficiency WLAN signaling field such as HE-SIG-B), a WLAN STF (e.g., a high efficiency WLAN STF), and at least one WLAN LTF (e.g., at least one high efficiency WLAN LTF). The high efficiency WLAN preamble 215 may enable an AP to simultaneously transmit to multiple stations (e.g., MU-MIMO) and may also enable an AP to allocate resources to multiple stations for uplink/downlink transmissions (e.g., SU-OFDMA). The high efficiency WLAN preamble 215 may use a common signaling field and one or more dedicated (e.g., station-specific) signaling fields to schedule resources and to indicate the scheduling to other WLAN devices. A device may use the scheduling to determine which resource units associated with the frequency spectrum utilized by data field 220 have been allocated to the device for forthcoming communications.

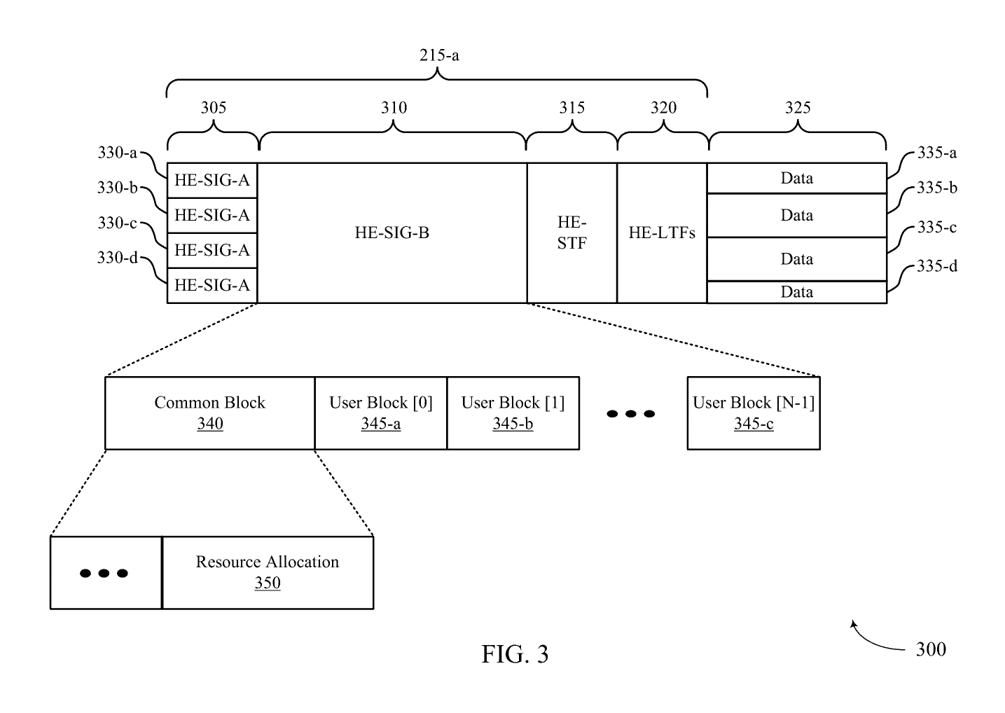

FIG. 3 illustrates an example of aspects of a WLAN protocol data unit 300 for resource allocation signaling in a high efficiency WLAN preamble in accordance with various aspects of the present disclosure. WLAN protocol data unit 300 illustrates aspects of a transmission between a STA 110 and an AP 105, as described above with reference to FIGS. 1-2. WLAN protocol data unit 300 may include a first WLAN signaling field 305, a second WLAN signaling field 310, a high efficiency STF 314, a high efficiency LTF 320, and a data field 325. The first WLAN signaling field 305 may include an HE-SIG-A 330 that is repeated across multiple sub-bands. The data field 325 includes data portions 335 that have been allocated to different devices. For instance, data portion 335-a is allocated to a first device, data portion 335-b to a second device, data portion 335-c to a first group of devices, and data portion 335-d to a second group of devices.

The first WLAN signaling field 305 may include high efficiency WLAN signaling information usable by APs and stations other than a number of APs or stations identified to receive or transmit communications in the WLAN protocol data unit 300. The first WLAN signaling field 305 may also include information usable by the identified number of APs or stations to decode the second WLAN signaling field 310. When the radio frequency spectrum band includes multiple sub-bands, the information (e.g., HE-SIG-A 330-a) included in the first WLAN signaling field 305 may be duplicated and transmitted in each sub-band of the first WLAN signaling field 305, (e.g., HE-SIG-A 330-b to 330-d).

The second WLAN signaling field 310 may include high efficiency WLAN signaling information usable by a number of APs or stations identified to transmit or receive communications in the WLAN protocol data unit 300. More specifically, the second WLAN signaling field 310 may include information usable by the number of APs 105 or stations (STAs) 110 to transmit/encode or receive/decode data in the data field 325. The second WLAN signaling field 310 can be encoded separately from the first WLAN signaling field 305. The second WLAN signaling field 310 may include a common block field 340 that signals information to a group of devices, such as high efficiency STAs within range of an AP 105, and user blocks 345-a to 345-c that signal information specific to specific high efficiency STAs. The common block field 340 may be a common user field or a common station field, and the common user field or common station field may decodable by one or more stations or other wireless devices receiving the common user field or common station field. The common block may include a resource allocation field 350 that signals to the high efficiency device how the data field 325 may be partitioned amongst devices (e.g., partitions the data field into resource units), which resource units may be associated with SU-OFDMA, and which resource units may be associated with MU-MIMO. Furthermore, the order of the user blocks 345 may provide a link between the device associated with the user block 345 and the resource unit that may be allocated to the device. As an example, the resource allocation field 350 may partition the data field into nine regions (e.g., 20 MHz data region is partitioned into nine sub-regions that each span 26 tones). The STA addressed in the first user block may correspond to the first 26 tones, the second STA addressed in the second user block corresponds to the next 26 tones, etc. The common block may also include other fields, such as an LTF.

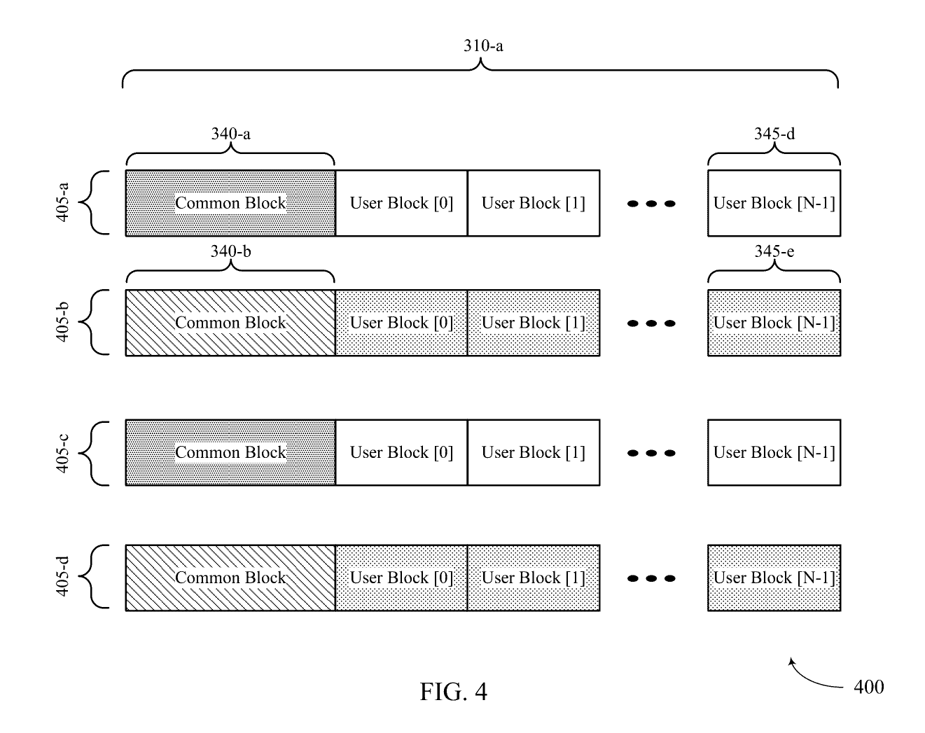

FIG. 4 illustrates an example of aspects of a WLAN protocol data unit 400 for resource allocation signaling in a high efficiency WLAN preamble in accordance with various aspects of the present disclosure. WLAN protocol data unit 400 illustrates aspects of a transmission between a STA 110 and an AP 105, as described above with reference to FIGS. 1-2. WLAN protocol data unit 400 includes a second WLAN signaling field 310-a (e.g., an HE-SIG-B field), which may be an example of a second WLAN signaling field 310. Second WLAN signaling field 310-a may include four sub-bands that supports four streams 405-a to 405-d of control information. Streams 405-c and 405-d may be redundant versions of streams 405-a and 405-b, which may include the resource allocation and scheduling information for a number of devices. In one example, a device may decode both streams to acquire all of the content signaled in the second WLAN signaling field 310-a. Furthermore, a device that receives a user block within a frequency band associated with a stream 405 also may have also received data within the same frequency band. The common and dedicated content (e.g. the information in common block fields 340-a and 340-b, and user blocks 345) for every other 20 MHz channel may be signaled together.

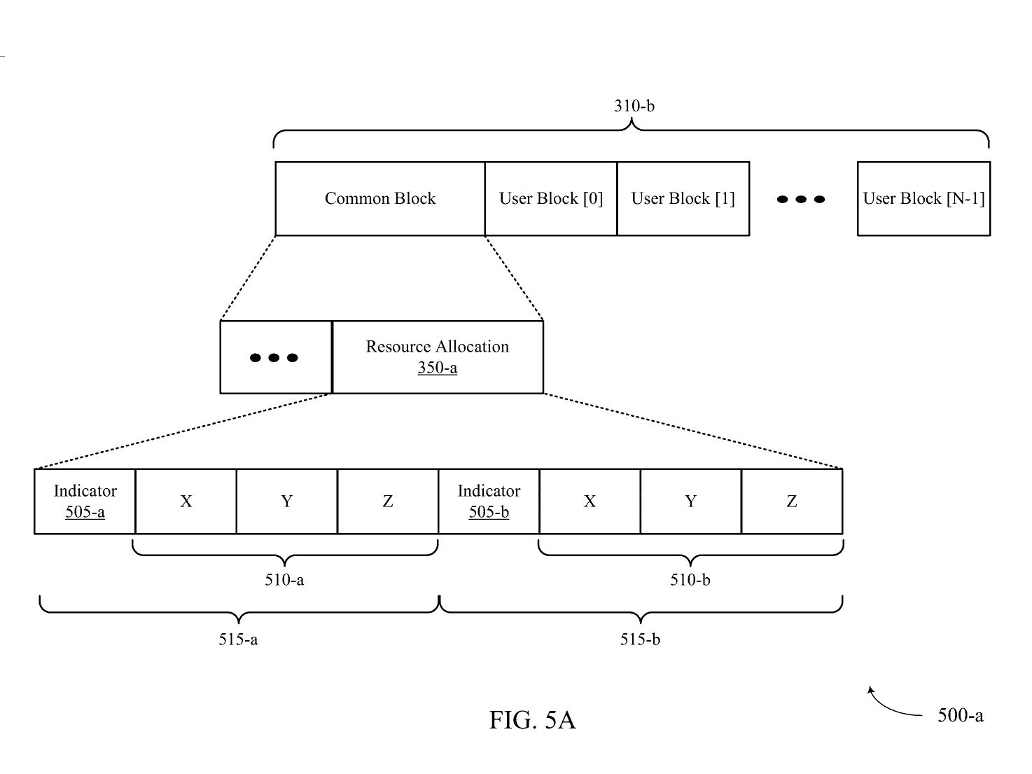

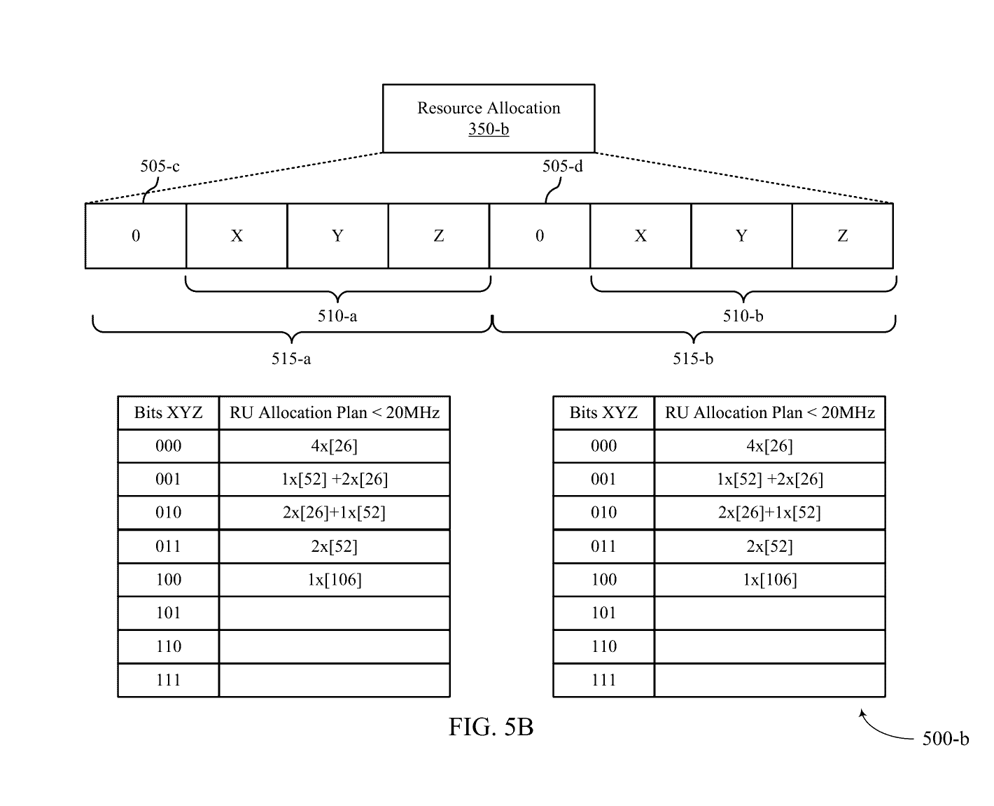

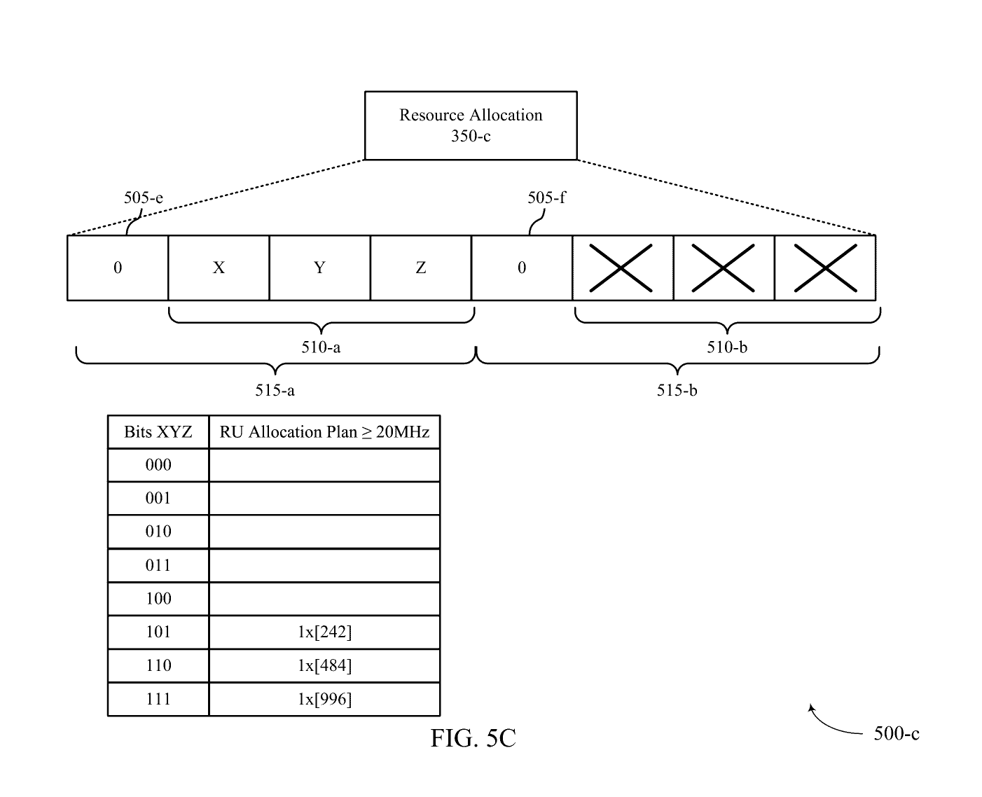

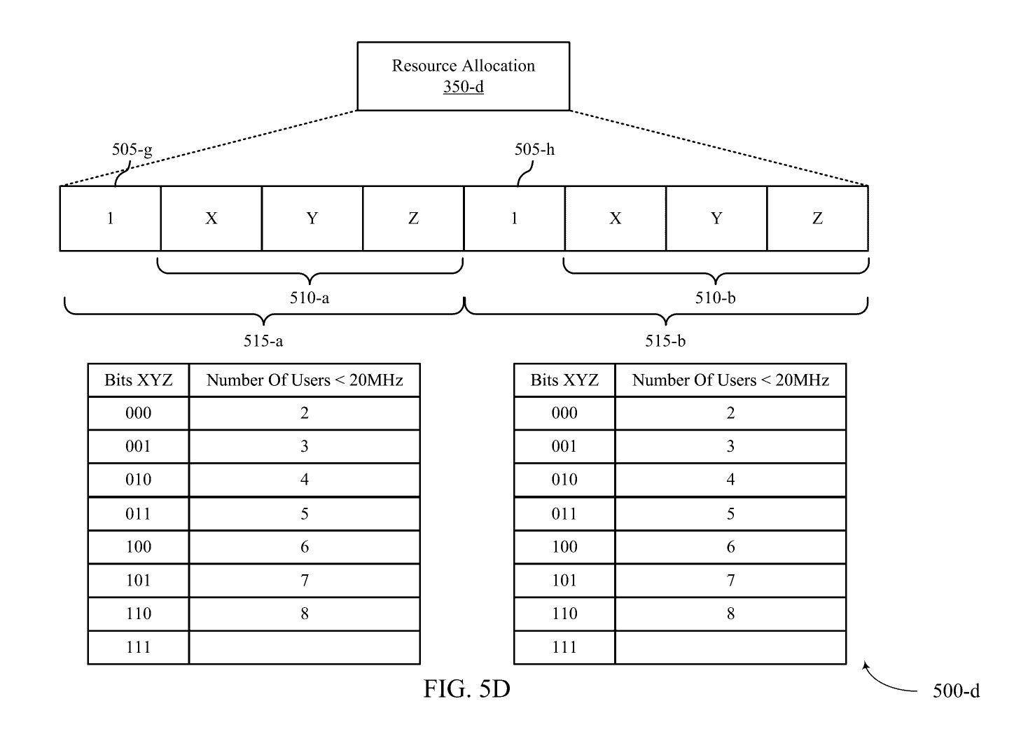

FIGS. 5A-5F illustrate examples of a resource allocation scheme 500 for resource allocation signaling in a high efficiency WLAN preamble in accordance with various aspects of the present disclosure. Resource allocation scheme 500 illustrates aspects of a transmission between a STA 110 and an AP 105, as described above with reference to FIGS. 1-4. Resource allocation scheme 500 may include a second WLAN signaling field 310-b (e.g., an HE-SIG-B field), and resource allocation field 350-a. Resource allocation field 350-a may include a first portion 515-a and a second portion 515-b. The first portion 515-a may include an indicator 505-a and indices 510-a, while the second portion 515-b may include an indicator 505-b and indices 510-b.

In one example, the resources allocated in the first portion 515-a correspond to a first portion of the bandwidth allocated to subsequent data transmissions (e.g., the first 10 MHz of a 20 MHz channel). The resources allocated in the second portion 515-b correspond to the second portion of the allocated bandwidth (e.g., the next 10 MHz of the 20 MHz channel). The indicators 505, with respect to one another and based at least in part on the information provided in indices 510, indicate to a set of enhanced devices that an upcoming transmission is SU-OFDMA or MU-MIMO, the resource allocation pattern (e.g., the size of the allocated resource units), and/or the number of users participating in an MU-MIMO transmission. The indicators 505 are one of an allocation plan indicator or a resource type indicator.

For example, if the first indicator 505-a is an allocation plan indicator (e.g., bit value 0) and the second indicator 505-b is an allocation plan indicator, then, for narrow band resource allocations (e.g., less than 20 MHz) the indices 510-a and 510-b may signal how a 20 MHz band is partitioned for an SU-OFDMA. In some examples, the indicators may be signaled with a bit and the indices may be signaled using three bits, for example to produce a resource allocation field 350-a that is constructed from eight bits. Additional examples of resource allocation scheme 500 are presented in the following discussion below.

FIG. 5B illustrates an example of a resource allocation scheme 500-b. In this example, an SU-OFDMA resource allocation scheme for narrow band resource allocations (e.g., less than 20 MHz) is presented. The first indicator 505-c is signaled as an allocation plan indicator using bit value 0. Accordingly, the indices 510-a is used to signal the resource allocation pattern for a 20 MHz channel. For instance, if indices 510-a signals ‘000’ a device that decodes the resource allocation field 350-b determines that the first 10 MHz of the 20 MHz is partitioned into four resource units that span 26 tones. Alternatively, if indices 510-a signals ‘100’ the device determines that the full first 10 MHz is allocated to a single user. The second indicator 505-d also signals a bit value 0 and therefore signals an allocation plan indication. Similar to the above, based on indices 510-b a device that decodes a resource allocation field 350-b may determine how the second portion (e.g., the next 10 MHz portion of the 20 MHz channel) is allocated.

FIG. 5C illustrates an example of a resource allocation scheme 500-c. In this example, an OFDMA resource allocation scheme for wide band resource allocations (e.g., greater than or equal to 20 MHz) to single users is presented. The first indicator 505-e is signaled as an allocation plan indicator using bit value 0. Accordingly, the indices 510-a is used to signal the resource allocation pattern for a wide band channel (e.g., 20 MHz, 40 MHz, 80 MHz, etc.). For instance, if indices 510-a signals ‘101’ a device that decodes the resource allocation field 350-c determines that the entire 20 MHz channel is allocated to a single resource unit. Alternatively, if indices 510-a signals ‘111’ the device determines that the entire 80 MHz channel is allocated to a single resource unit. The second indicator 505-f also signals a bit value 0, which indicates to a device that the resource allocation is not associated with MU-MIMO transmissions. In this example, the device identifies that the resource allocation is greater than 20 MHz and that the first and second portions of the 20 MHz are allocated. Accordingly, the device ignores signaling in indices 510-b.

FIG. 5D illustrates an example of a resource allocation scheme 500-d. In this example, an MU-MIMO resource allocation scheme for narrow band resource allocations (e.g., less than 20 MHz) is presented. The first indicator 505-g is signaled as a resource type indicator using bit value 1. Accordingly, the indices 510-a is used to signal the number of users assigned to a resource unit (e.g., 2 to 8) for an MU-MIMO transmission. In this example, resource allocation less than 10 MHz (e.g., less than 106 tones) are not allocated for MU-MIMO transmissions. Accordingly, a device determines that since the resource assignment is less than 20 MHz (e.g., 242 tones) that the MU-MIMO assignment is 106 tones. Therefore, if indices 510-a signals ‘000’ a device that decodes the resource allocation field 350-b determines that the first portion of the 20 MHz channel (e.g. the first 106 tones) have been assigned to two users. Alternatively, if indices 510-a signals ‘110’ the device determines that the first portion of the channel has been assigned to eight users. In this example, the second indicator 505-h also signals a bit value 1. A device may similarly determine how many users have been scheduled for the second portion of the 20 MHz channel.

FIG. 5E illustrates an example of a resource allocation scheme 500-e. In this example, an MU-MIMO resource allocation scheme for wideband band resource allocations (e.g., greater than or equal to 20 MHz) is presented. In this example, a device determines that the MU-MIMO transmission will be greater than or equal to 20 MHz. A device determines that a wideband MU-MIMO transmission will occur and for how many users by parsing the first and second portion of the resource allocation field 350-e. The first indicator 505-i is signaled as a resource allocation plan indicator using bit value 0. Accordingly, the indices 510-a is used to signal the resource allocation pattern. Furthermore, the first indices 510-a signals that the resource unit allocation is for resource units greater than or equal to 20 MHz (e.g., by signaling ‘101’, ‘110’, or ‘111’). The device then determines that the wideband resource allocation is for MU-MIMO transmission by identifying the second indicator 505-j signals a resource type indicator using bit value 1. Therefore, the device decodes indices 510-b to determine the number of users that are associated with the resource unit allocated by the first portion 515-a.

FIG. 5F illustrates an example of a resource allocation scheme 500-f. In this example, an resource allocation scheme for resource allocation of a 160 MHz band is presented. In this example, first indicator 505-k and indices 510-a signal ‘1111’ to a device. The indices associated with ‘111’ has been left free and therefore, for a resource type indicator, can be used to signal a 160 MHz band allocation. The 160 MHz can be signaled for either a SU-OFDMA transmission or an MU-MIMO transmission. For instance, to signal an MU-MIMO transmission the device signals a resource type indicator (e.g., ‘1’) at indicator 505-1. Indices, 510-b is then used to specify the number of devices associated with the 160 MHz resource unit allocation. To signal a SU-OFDMA transmission the first portion also signals ‘1111’. However, the second portion signals a resource allocation type at indicator 505-1 using a bit value 0. Accordingly, a device determines that the full 160 MHz bandwidth has been assigned to a single device.

Alternatively, a device signals an 80 MHz bandwidth allocation in two 20 MHz channels in a primary 40 MHz band. The device determines if the 160 MHz is allocated to SU-OFDMA by identifying that a single user block is transmitted subsequent to a common block. The device determines the 160 MHz is associated with an MU-MIMO transmission by identifying that each common block contains an 80 MHz distribution and the same number of users and by identifying that a single set of user content is transmitted in the dedicated portion. Additionally or alternatively, a device signals a 160 MHz bandwidth allocation in two 20 MHz and also duplicating the single user block in the two 20 MHz channels. The device determines the 160 MHz is associated with an MU-MIMO transmission by identifying that the same number of users is duplicated on the two 20 MHz portions.

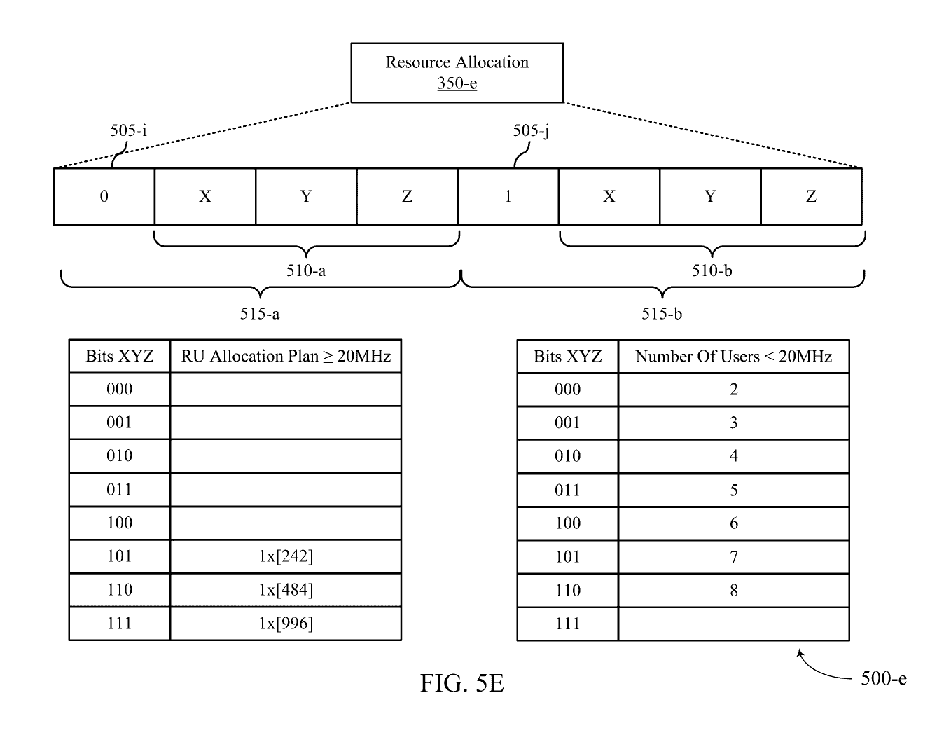

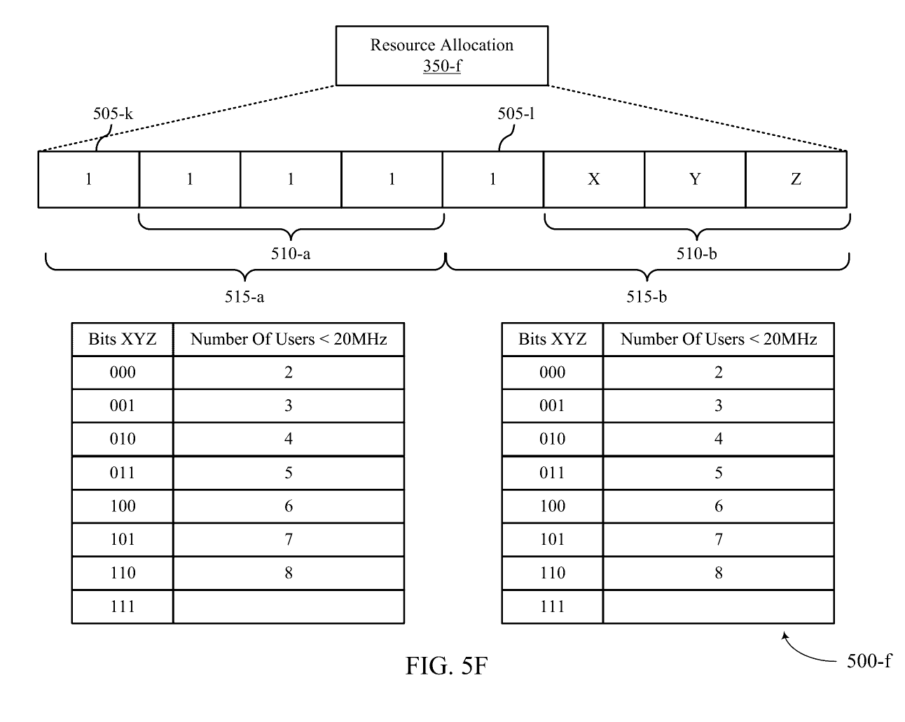

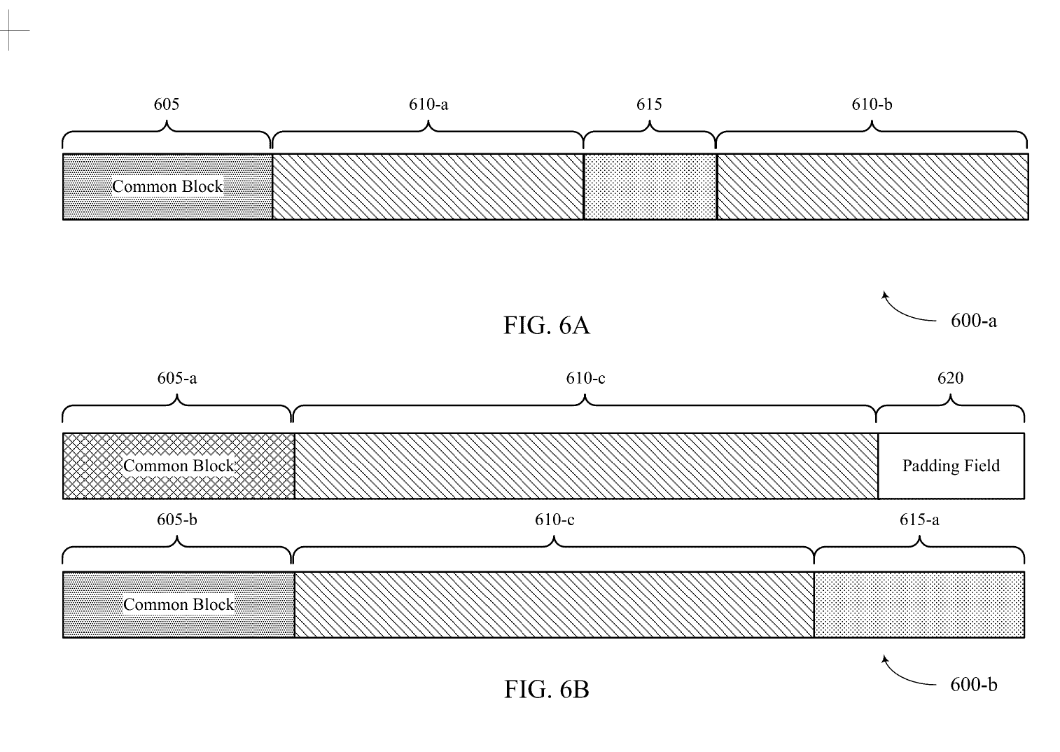

FIGS. 6A and 6B illustrate examples of common and dedicated block signaling for an HE-SIG-B field 600 that supports resource allocation signaling in a high efficiency WLAN preamble in accordance with aspects of the present invention. HE-SIG-B field 600 may be an example of a second WLAN signaling field. In this example, HE-SIG-B field 600 includes a common block 605, first dedicated content blocks 610-a associated with the first portion of a channel bandwidth, second dedicated content blocks 610-b associated with the second portion of the channel bandwidth, and a center dedicated content block 615 associated with a center tone resource unit.

FIG. 6A illustrates an example of the signaling in an HE-SIG-B field 600-a to indicate the center 26 tones of a resource allocation are allocated to a certain user. A resource distribution such as provided in FIG. 5B allocates four 26 tone resource units to a first portion of a channel and four 26 tone resource unit to a second portion of a channel. This leaves 13 tones at the end of the first portion and the beginning of the second portion for a total of 26 central tones. This center 26 tone resource unit is implicitly signaled to a specific user via a center dedicated content block 615. The devices that receive HE-SIG-B field 600-a identify that the resource unit allocation in the first dedicated content blocks 610-a and the second dedicated content blocks 610-b are for resource unit sizes that are less than 20 MHz. Furthermore, the device identifies a central user block, such as a user block 345 described in FIGS. 3 and/or 4, in the center of the user block distribution scheme. The device associated with the central user block corresponding to the center dedicated content block 615 identifies the center 26 tones are allocated to the associated device.

FIG. 6B illustrates an example of the signaling in an HE-SIG-B field 600-b to indicate the center 26 tones of a resource allocation are allocated to a certain user for a wideband allocation. For instance when the resource unit allocation is 80 MHz an extra 26 tone RU is available between two 40 MHz resource units. The first common block 605-a is associated with the second and fourth 20 MHz resource units, while common block 605-b is associated with the first and third 20 MHz resource units. The dedicated content for the 26 center tones is provided at the end of the primary 20 MHz channel in center dedicated content block 615-a. The secondary 20 MHz channel includes a padding field 620 to compensate for the disparity in signaling between the secondary and primary 20 MHz channels.

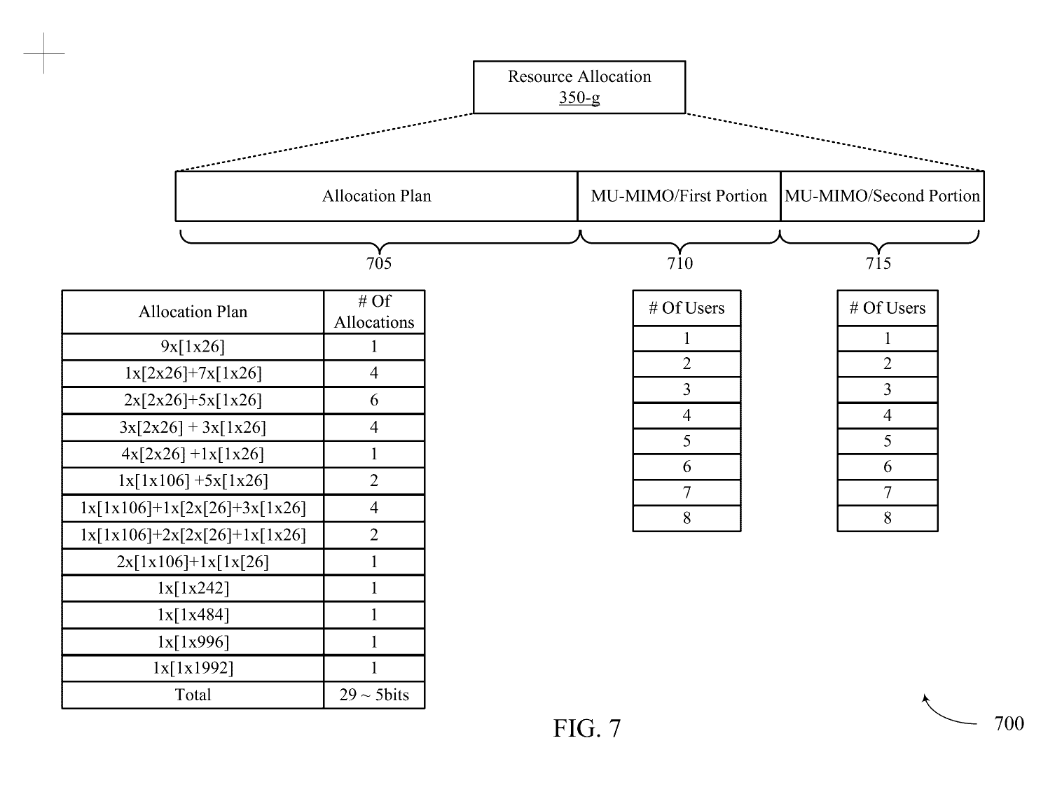

FIG. 7 illustrates an example of a resource allocation scheme 700 that supports resource allocation signaling in a high efficiency WLAN preamble in accordance with aspects of the present invention. Resource allocation field 350-g includes an allocation plan field 705, a first MU-MIMO field 710 for the first portion of a channel, and a second MU-MIMO field 715 for the second portion of the channel. The allocation plan field 705 corresponds to each the different allocation associated with an allocation plan. For instance, if nine 26 tone resource units are allocated then there is one allocation pattern to consider. For the allocation plan provided in this example, the different number of allocations totals 29 and can be represented using 5 bits. The first MU-MIMO field 710 is used to indicate the number of MU-MIMO users associated with resource units in a first channel portion, while the second MU-MIMO field 715 is used to indicate the number of MU-MIMO users associated with a second channel portion. For instance, for a resource allocation that includes two 106 tone resource units, the number of users indicated in the first MU-MIMO field 710 corresponds to the first 106 tones, while the number of users in the second MU-MIMO field 715 corresponds to the second 106 tones. For examples where resource units greater than or equal to 20 MHz are allocated, the first MU-MIMO field 710 indicates the number of users associated with the wideband allocation and the second MU-MIMO field 715 is unused. For examples where less than 10 MHz allocations (e.g., 26 tones, 52 tones, etc.) are allocated the first MU-MIMO field 710 and the second MU-MIMO field 715 are unused. For two 106 tone allocations, the first MU-MIMO field 710 and the second MU-MIMO field 715 may also be used to indicate that the first and second portions are associated with a SU-OFDMA transmissions, the first portion is SU-OFDMA and the second portion is MU-MIMO, and the like.

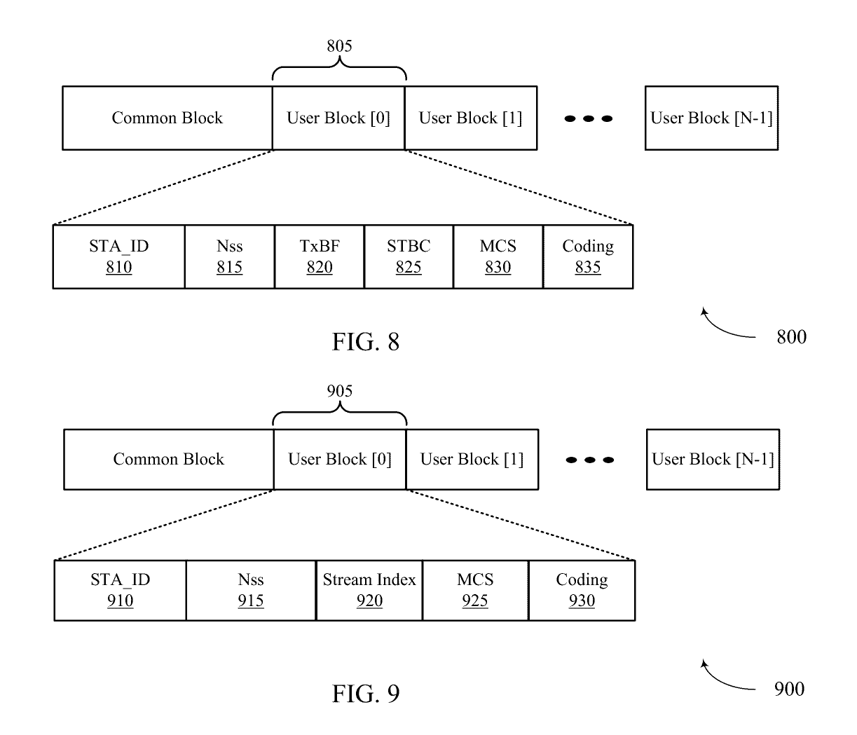

FIG. 8 illustrates an example of an HE-SIG-B field 800 that supports resource allocation signaling in a high efficiency WLAN preamble in accordance with aspects of the present invention. HE-SIG-B field 800 includes dedicated user blocks, including dedicated user block 805, which include additional fields, such as a station identification (ID) field 810, a spatial stream indicator 815, a transmit beamforming field 820, a space time block coding (STBC) field, an modulation coding scheme (MCS) field, a coding field 835, and a stream index 840.

FIG. 8 illustrates a dedicated user block 805 that is associated with SU-OFDMA transmissions. The station ID field 810 is used to identify an intended recipient for the user block, the spatial stream indicator 815 indicates the number of scheduled streams scheduled for a device, transmit beamforming field 820 which indicates whether transmit beamforming is utilized for transmission to the device, STBC field 825 which indicates the space time block code used for a transmission to the device, the MCS field 830, which indicates the modulation and coding scheme used for the corresponding data transmission, and the coding field 835. As explained above, the order that the dedicated user blocks, including dedicated user block 805, are transmitted corresponds to the resource unit allocation. That is, each resource unit is associated with a position of each user block.

FIG. 9 illustrates a dedicated user block 905 that is associated with MU-MIMO transmissions. The dedicated user block 905 includes a station ID field 910, spatial stream indicator 915, stream index 920, which indicates the index of the first stream and additional streams assigned to the device designated in the station ID field 910, MCS field 925, and coding field 930. Group IDs can be indicated in the common block for MU-MIMO allocations.

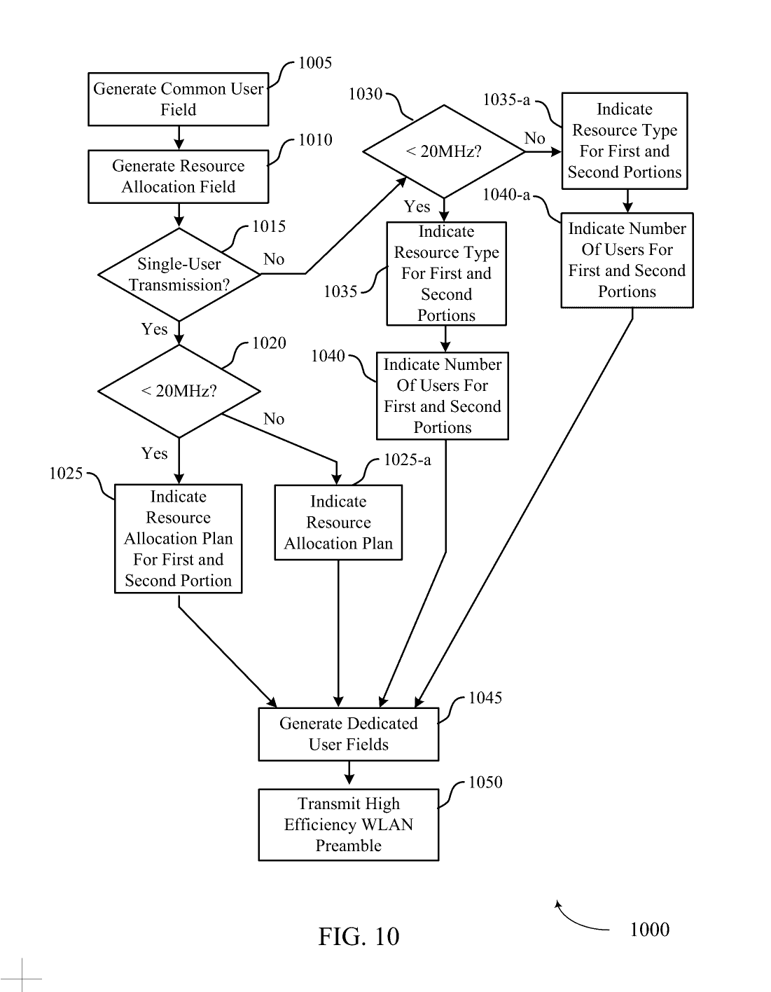

FIG. 10 shows a flow chart that illustrates one example of a method 1000 for wireless communication, in accordance with various aspects of the present disclosure. The method 1000 can be performed by any of the wireless devices, including APs 105, or STAs 110 discussed in the present disclosure.

Broadly speaking, the method 1000 illustrates a procedure by which a wireless device, such as a STA 110 or an AP 105, generates a WLAN signaling field that includes a common user field that is decodable by multiple stations and that may include a resource allocation field that indicates one or more communication resource units in a MU-PPDU and further indicates that a communication resource unit is associated with a MU-MIMO or an OFDMA single-user transmissions. The device also generates in the WLAN signaling field, subsequent to the common field, station specific fields, where the position of the station specific fields corresponds to the resource units allocated by the resource allocation field and transmits a WLAN preamble including the WLAN signaling field.

At 1005, the wireless device generates a common user field in a WLAN signaling field. The common user field is decodable by multiple stations and includes a resource allocation field that partitions a set of frequency resources between multiple devices.

At 1010, the wireless device generates the resource allocation field. The resource allocation field indicates a resource unit allocation pattern (e.g., a breakdown of the set of frequency resources into one or more resource units) and also indicates that a resource unit in an MU-PPDU is associated with an MU-MIMO transmission or an OFDMA single-user transmission.

At 1015, the wireless device determines if a resource unit allocation for an MU-PPDU is associated with an OFDMA single-user transmission (e.g., if the resource unit allocation pattern is intended for single device communication).

At 1020, after determining a resource unit allocation is associated with an OFDMA single-user transmission, the wireless device determines if the resource unit allocation allocates resource units that are less than 20 MHz in frequency. The wireless device indicates to another device that following indices are associated with a resource distribution, and the following indices are used to designate a resource pattern and the size of the resource units.

At 1025, after determining the frequency associated with the resource unit allocation is below 20 MHz and that the resource unit is associated with an OFDMA single-user transmission, the wireless device determines an allocation plan for the first and second portion of a 20 MHz band. The wireless device indicates to a device that a following index is associated with a resource distribution. The following index designates resource unit patterns that include resource units that span up to 52 tones. The wireless device further partitions a 20 MHz bandwidth into first and second 10 MHz portions. The wireless device is provided a first allocation plan indicator, a second allocation plan indicator and corresponding resource allocation indices for both the first and second portion.

At 1025-a, after determining the frequency associated with the resource unit allocation is greater than or equal to 20 MHz based on the indices and that the resource unit is associated with an OFDMA single-user transmission, the wireless device determines an allocation plan for the full resource unit. The first allocation plan indicator is used to indicate to a device that a following index is associated with a resource distribution. The following index designates single resource units that include 242 to 996 tones in frequency (e.g., 20 MHz to 80 MHz).

At 1030, after determining that a transmission is not an OFDMA single-user transmission (e.g., is an MU-MIMO transmission), the wireless device determines if the resource allocation is less than 20 MHz. A resource type is indicated to a device that the following indices are associated with the number of users assigned to receive information over a resource unit.

At 1035, after determining a transmission is associated with an MU-MIMO transmission and identifying the resource unit allocation is less than 20 MHz, the wireless device indicates that the transmission is an MU-MIMO transmission by including a resource type indication in the resource allocation field. The resource unit associated with the resource type indication may implicitly be determined to be 106 tones based on identifying that the resource units are less than 20 MHz and by determining that MU-MIMO allocations less than 106 tones are not supported. The wireless device partitions the 20 MHz bandwidth into first and second 10 MHz portions. The resource type indication associated with both the first and second portions along with the following indices to designate the number of users for a first MU transmission over the first portion and the number of users for a second MU transmission over the second portion. For resource unit allocations smaller than 20 MHz, the resource type indication can also be combined with the allocation plan indicator to indicate that a first portion is associated with an OFDMA single-user transmission and a second portion is associated with an MU-MIMO transmission and vice versa.

At 1040, the indices included in the resource allocation field and following the resource type indicator are used to indicate the number of users that are associated with the allocated resource units in both the first and second portions.

At 1035-a, after determining a transmission is associated with an MU-MIMO transmission and identifying the resource unit allocation is greater than or equal to 20 MHz, wireless device indicates that the transmission is a wideband MU-MIMO transmission by including the allocation plan indication in the resource allocation field and by indicating with the following indices that the resource unit distribution is greater than 20 MHz. Furthermore, to distinguish the wideband MU-MIMO transmission form the wideband OFDMA single-user transmission, a resource type indication is included in the second portion of the resource allocation field.

At 1040-a, the indices following the resource type indication may be used to indicate the number of users participating in the wideband MU-MIMO transmission.

At 1045, the wireless device generates the dedicated user fields subsequent to the common field. The wireless device generates the dedicated user fields in an order that corresponds the resource unit allocation pattern. For example, the first portion of a 20 MHz band may be allocated to four 26 tone resource units and the second portion of the 20 MHz band may also be allocated to four 26 tone resource units. Accordingly, the first dedicated user block may correspond to the first 26 tone resource unit and by extension the device assigned to the first dedicated user block is allocated the first 26 tone resource unit. For resource unit allocations of less than 20 MHz, there are 26 tones in the center of the 20 MHz bandwidth that are not assigned by the resource allocation pattern (e.g., 13 unassigned tones in the first portion and 13 unassigned tones in the second portion). Accordingly, the wireless device inserts dedicated user block corresponding to the center tones between the dedicated user blocks corresponding to the first portion and the dedicated user block corresponding to the second portion a. Similarly, for resource unit allocations of 80 MHz or 160 MHz, the center 26 tones are unassigned. In this example, the wireless device generates a dedicated user block corresponding to the center tones at the end of the primary 20 MHz channel including the common and dedicated portions.

At 1050, the WLAN signaling field may be included in the high efficiency WLAN preamble and a WLAN preamble, which includes the high efficiency WLAN preamble, is transmitted over the WLAN channel.

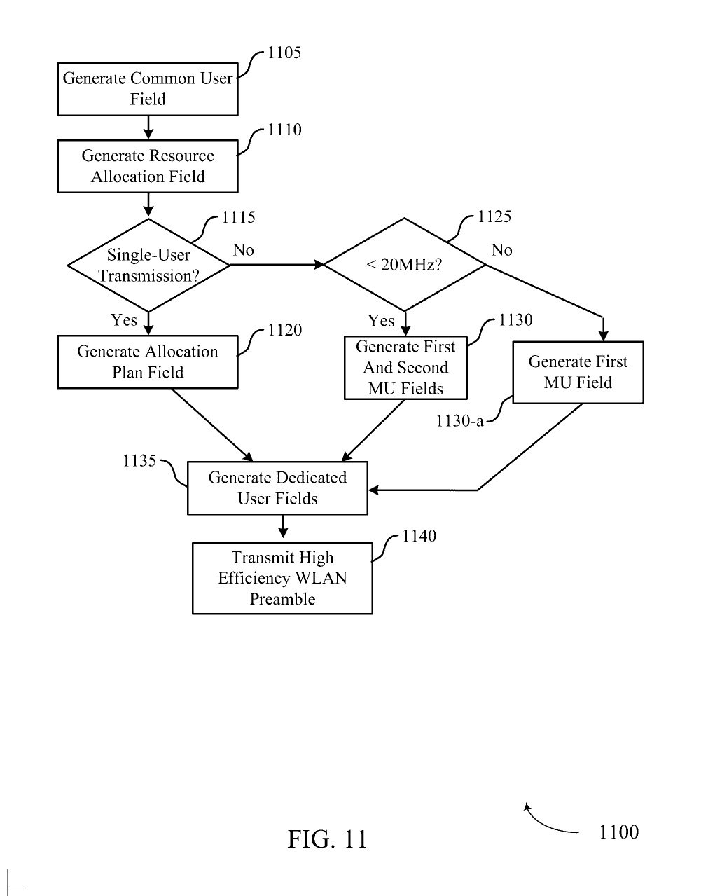

FIG. 11 shows a flow chart that illustrates one example of a method 1100 for wireless communication, in accordance with various aspects of the present disclosure. The method 1000 can be performed by of the wireless devices, including APs 105, or STAs 110, discussed in the present disclosure.

Broadly speaking, the method 1100 illustrates another procedure by which a device, such as a STA 110 or an AP 105, generates a WLAN signaling field that includes a common user field that is decodable by multiple stations and that may include a resource allocation field that indicates one or more communication resource units in a MU-PPDU and further indicates that a communication resource unit is associated with a multi-user or an OFDMA single-user transmissions. The device also generates in the WLAN signaling field, subsequent to the common field, station specific fields, where the position of the station specific fields corresponds to the resource units allocated by the resource allocation field and transmits a WLAN preamble including the WLAN signaling field.

At 1105, the wireless device generates a common user field in a WLAN signaling field. The common user field is decodable by multiple stations and includes a resource allocation field that partitions a set of frequency resources between multiple devices.

At 1110, the wireless device generates the resource allocation field. The resource allocation field indicates a resource unit allocation pattern (e.g., a breakdown of the set of frequency resources into one or more resource units) and also indicates that a resource unit in an MU-PPDU is associated with an MU-MIMO transmission or an OFDMA single-user transmission. The resource allocation field includes an allocation plan field, and multi-user fields that correspond to a first and second portion of a channel, as generally described in FIG. 7.

At 1115, the wireless device determines if a resource unit allocation in a MU-PPDU is associated with an OFDMA single-user transmission (e.g., if the resource unit allocation pattern is intended for single device communication).

At 1120, the wireless device generates the allocation plan field. The allocation plan field indicates the resource allocation pattern from a number of available resource allocation patterns (e.g., using a 5 bit look up table). For OFDMA single-user transmission only the allocation plan field is utilized. The allocation plan field can indicate both narrow band (e.g., less than 20 MHz) and wide band (e.g., greater than or equal to 20 MHz) transmissions to a device.

At 1125, after identifying the transmission is an MU-MIMO transmission the wireless device determines whether the resource unit allocation includes resource units less than 20 MHz.

At 1130, after identifying the resource unit allocation are less than 20 MHz the wireless device identifies that a resource unit is associated with an MU-MIMO transmission. The wireless device identifies the number of users assigned to the resource unit associated with the first portion of the 20 MHz in a first MU field and the number of users assigned to the second portion of the 20 MHz in a second MU field. As mentioned above, for resource unit allocation less than 106 tones the resource allocation field generator will not support MU-MIMO transmissions. Accordingly, MU fields included in the resource type indicator are unused for MU-MIMO transmissions less than 106 tones in frequency.

At 1130-a, after identifying the resource unit allocation are greater than or equal 20 MHz and identifying that the resource unit is associated with an MU-MIMO transmission, the wireless device uses the first MU field to indicate the number of user associated with the wideband MU-MIMO transmission.

At 1135, the wireless device generates the dedicated user fields subsequent to the common field. The wireless device generates the dedicated user fields in an order that corresponds the resource unit allocation pattern. For example, the wireless device indicates the resource allocation pattern (e.g., nine 26 tone resource units) that includes the center resource unit implicitly signaled in method 1000. Each dedicated user field then corresponds to the nine resource units (e.g., the first user field corresponds to the first allocated resource unit, the second user field to the second allocated resource unit, and so on.)

At 1140, the WLAN signaling field is included in the high efficiency WLAN preamble and a WLAN preamble, which includes the high efficiency WLAN preamble, is transmitted over the WLAN channel. Aspects of method 1000 and 1100 may be combined and/or performed in different orders than those described above.

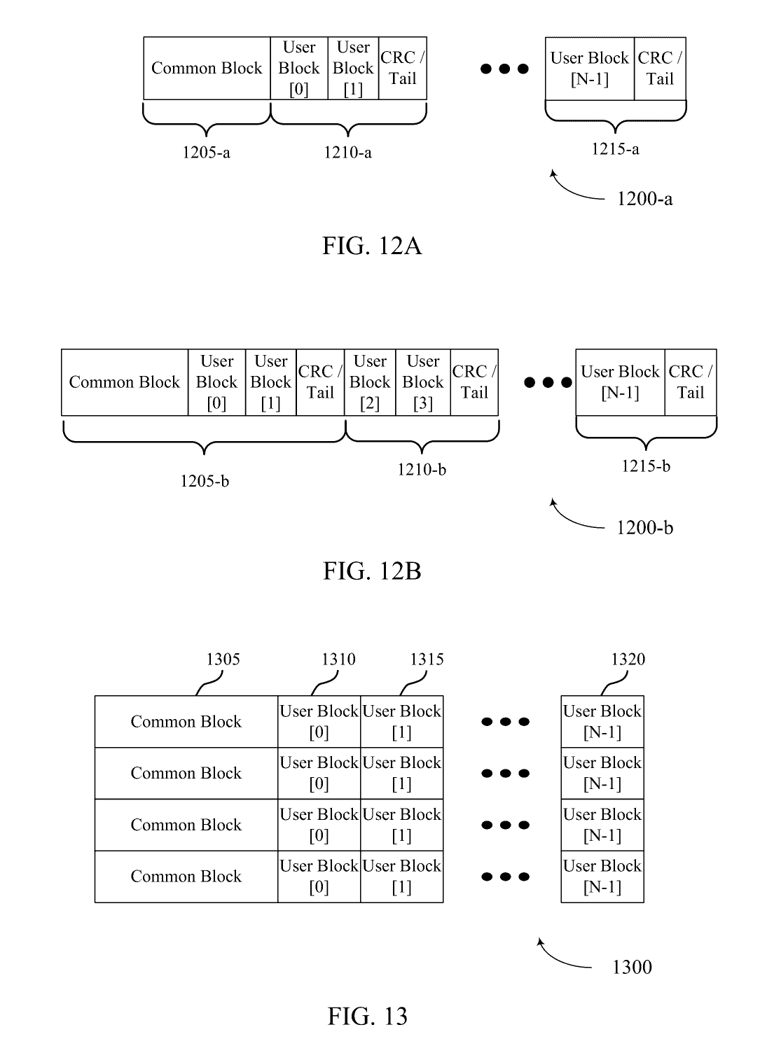

FIGS. 12A-12B show examples of an encoding structure in accordance with various aspects of the present disclosure. In these examples, the second WLAN signaling field (e.g., an HE-SIG-B field) is split into common and dedicated portions. The common block field (common portion) contains the RU allocation information for the STAs in the corresponding 20 MHz channel. The dedicated portion contains per-user information for each STA. The encoding process is per 20 MHz and may be made up of binary convolutional coding (BCC) encoded codeblocks. Each codeblock may be jointly encoded and contain per-user info for ‘k’ users, and the boundary between codeblocks does not necessarily align with symbol boundaries. The decoding structure is based on one of the following two example options illustrated in FIGS. 12A and 12B.

First BCC block 1205-a may include a common block. BCC block 1210-a may include a BCC block for every K user blocks and a CRC and tail. A last BCC block 1215-a may include less than K user blocks and a CRC and tail. First BCC block 1205-b may include a common block, a BCC block for a first two users, and a CRC and tail. BCC block 1210-b may include a BC block for every K users and a CRC and tail. Last BCC block 1215-b may include less than K user blocks and a CRC and tail.

FIG. 13 shows an example of a transmission structure for a second WLAN signaling block 1300 in accordance with various aspects of the present disclosure. In this example, the second WLAN signaling block (e.g. an HE-SIG-B field) is transmitted in non-duplicated fashion in 40 MHz. For larger PPDU bandwidths, each 40 MHz is duplicated, e.g. twice for 80 MHz bandwidth. According to this example, a receiving STA may decode two 20 MHz channels in order to obtain all the SIG-B content. A common block 1305 and a dedicated user block (e.g., user block 1310, user block 1315, and user block 1320) for every other 20 MHz channel (1, 3, 5, 7 and 2, 4, 6, 8) may be signaled together.

FIGS. 14A and 14B show examples of common block field size tables 1400-a and 1400-b in accordance with various aspects of the present disclosure. A common block field may include one or more aspects of common block field 340 described with reference to FIGS. 1-8. The common block field may be included in a second WLAN signaling field, for example second WLAN signaling field 310 described with reference to FIGS. 1-8. In an allocation in the common portion, for both MU-MIMO and non-MIMO allocations, there may be the same number of bits in the common block field for a given bandwidth. In this example, the SU/MU-MIMO allocations may not be indicated in a first WLAN signaling field, for example an HE-SIG-A field. The size of the common block field, e.g. the number of common bits transmitted in the common block field, may depend on the number of channels in the bandwidth for the PPDU, and a size of the RUs that are allocated.

Common block field size table 1400-a shows the number of bits in a common block field based on the number of channels in a PPDU bandwidth, given in bandwidth. In this example, the second WLAN signaling field is an HE-SIG-B signaling field. For a bandwidth of 20 MHz or 40 MHz, there may be eight (8) bits in the common block field for an HE-SIG-B field. For a bandwidth of 80 MHz, there may be sixteen (16) bits in the common block field. For a bandwidth of 160 MHz, there may be thirty-two (32) bits in the common block field. Here, the number of bits is for both MU-MIMO and non-MIMO allocations.

Common block field size table 1400-b shows the number of bits when including an additional N bits that may not be a part of a resource allocation field of the common block field, but may be used to convey other types of information, for example bits indicating padding or packet extension, legacy training field (LTF), compression indication, number of LTFs in the PPDU, etc., as further described above. Where additional N bits are provided, the common portion size (size of the common block field) may be for example of size 8+N, 16+N, and 32+N, etc.

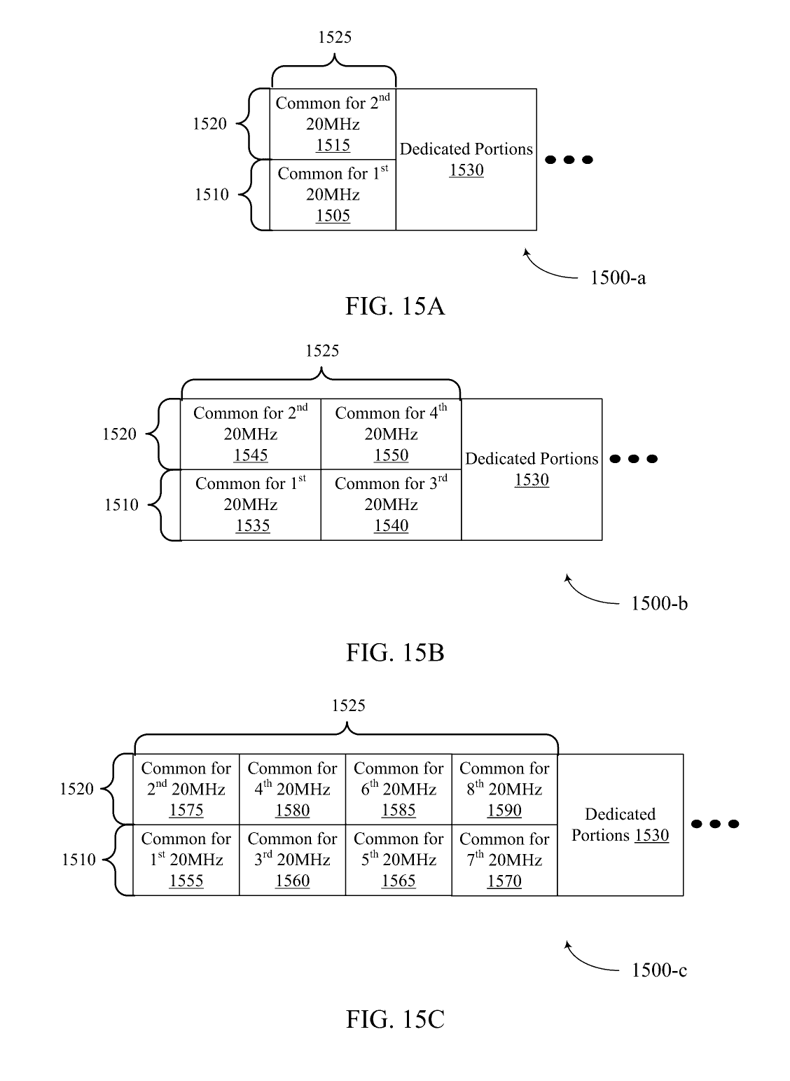

FIGS. 15A-15C show examples of a second WLAN signaling field 1500 in accordance with various aspects of the present disclosure. Second WLAN signaling field 1500 may include one or more aspects of second WLAN signaling field 310 described with reference to FIGS. 1-8. In one example, second WLAN signaling field 1500 is an HE-SIG-B field.

In FIG. 15A, a second WLAN signaling field 1500-a is illustrated for a PPDU having a bandwidth of 40 MHz. In such case, in a common block field 1525, an RU allocation for a first 20 MHz channel 1505 may be transmitted in the first eight bits of a first 20 MHz channel 1510. An RU allocation for a second 20 MHz channel 1515 may be transmitted in the first eight (8) bits of a second 20 MHz channel 1520. Dedicated portions 1530 of second WLAN signaling field 1500-a allocated to different users follows the common portions in each of the two 20 MHz channels.

FIG. 15B shows a second example of a second WLAN signaling field 1500-b in accordance with various aspects of the present disclosure. Second WLAN signaling field 1500-b may include one or more aspects of second WLAN signaling field 310 described with reference to FIGS. 3-5A. In FIG. 15B, a second WLAN signaling field 1500-b is illustrated for a PPDU having a bandwidth of 80 MHz. In such case, in the common block field 1525, RU allocations for a first 20 MHz channel 1535 and RU allocations for a third 20 MHz channel 1540 may be transmitted in the first sixteen (16) bits of the first 20 MHz channel 1520. RU allocations for the second 20 MHz channel 1545 and RU allocations for a fourth 20 MHz channel 1550 may be transmitted in the first sixteen (16) bits of the second 20 MHz channel 1520. The common block field for the first 20 MHz channel and the third 20 MHz channel are then repeated (duplicated) in the third channel 20 MHz channel, and the common block field for the second 20 MHz channel and the fourth 20 MHz channel are then repeated (duplicated) in the fourth channel 20 MHz channel.

FIG. 15C shows an example of a second WLAN signaling field 1500-c in accordance with various aspects of the present disclosure. Second WLAN signaling field 1500-c may include one or more aspects of second WLAN signaling field 310 described with reference to FIGS. 3-5A. In FIG. 15C, a second WLAN signaling field 1500-c is illustrated for a PPDU having a bandwidth of 160 MHz. In such case, in the common block field, RU allocations for a first 20 MHz channel 1555, RU allocations for a third 20 MHz channel 1560, RU allocations for a fifth 20 MHz channel 1565, and RU allocations for a seventh 20 MHz channel 1570 may be transmitted in the first thirty-two (32) bits of the first 20 MHz channel 1510. The RU allocations for each of the first 20 MHz channel, the third 20 MHz channel, the fifth 20 MHz channel, and the seventh 20 MHz channel are also transmitted in each of the third 20 MHz channel, the fifth 20 MHz channel, and the seventh 20 MHz channel. In the common block field 1525, the RU allocations for the second 20 MHz channel 1575, the RU allocations for fourth 20 MHz channel 1580, the RU allocations for sixth 20 MHz channel 1585, and the RU allocations for eighth 20 MHz channel 1590 may be transmitted in the first thirty-two (32) bits of the second 20 MHz channel 1520. The RU allocations for each of the second 20 MHz channel, the fourth 20 MHz channel, the sixth 20 MHz channel, and the eighth 20 MHz channel are also transmitted in duplicate in each of the fourth 20 MHz channel, the sixth 20 MHz channel, and the eighth 20 MHz channel.

As shown with regard to FIGS. 15A-15C, the size of the common block field 1525 (common portion) in the PPDU may correspond, or be mapped from, a bandwidth that is specified in the first WLAN signaling field, for example first WLAN signaling field 305 described above with reference to FIGS. 1-8. That is, when a bandwidth is known to a receiver, the receiver likewise knows the size of the common block field. One drawback of this approach is that it may be inefficient for RU allocations that are larger due to redundancy. As one example, as described above, thirty-two bits may be used in the common block field in each 20 MHz channel to communication RU allocation where the bandwidth is 160 MHz. However, if two 80 MHz allocation are to be made to two user devices, only eight (8) bits may be used in each 20 MHz channel to convey the RU allocations for these two devices. The remainder of the thirty-two bits (32), or twenty-four (24) bits, are redundant in each of the 20 MHz channels.

Certain approaches to reduce some of the above-described redundancies, for example, introducing additional common block field sizes, may add unwanted complexity to the common block field size. For example, this approach may require a STA that will receive a transmission to track multiple potential codeblock sizes, and/or it may be appropriate that additional bits be used in the first WLAN signaling field, for example additional bits in HE-SIG-A.

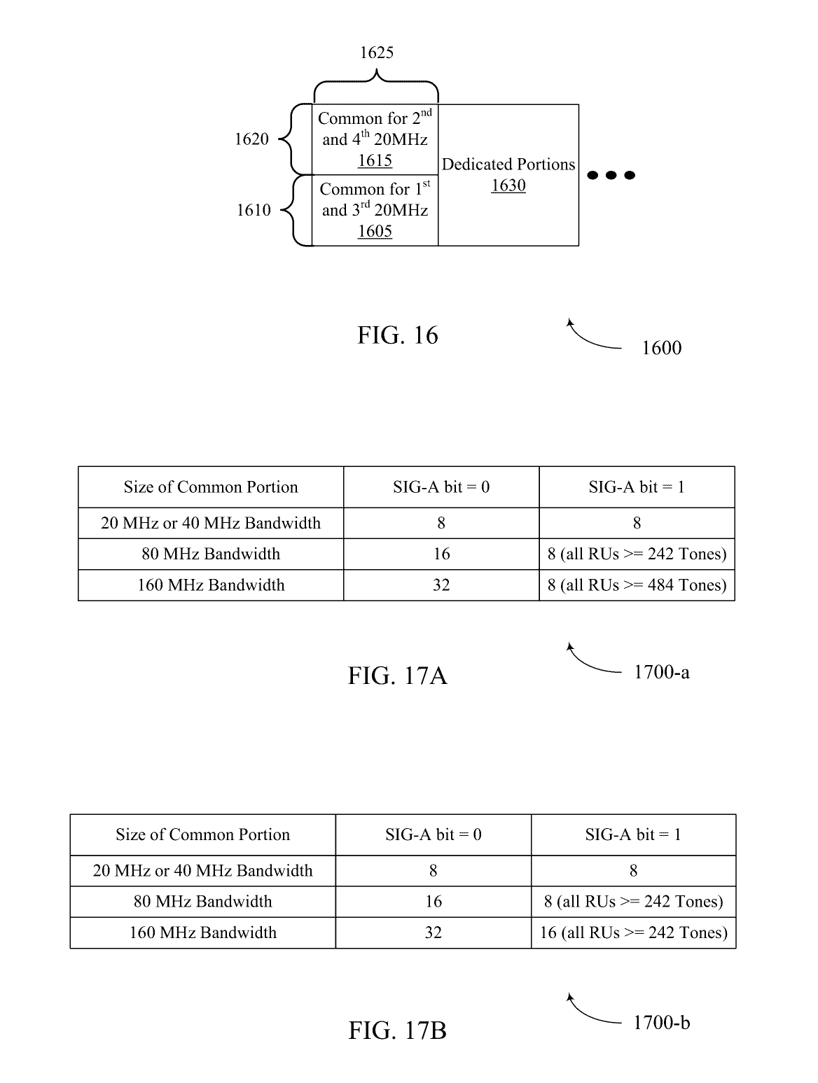

FIG. 16 illustrates an example of a second WLAN signaling field 1600 for a PPDU having a bandwidth of 80 MHz in accordance with various aspects of the present disclosure. Second WLAN signaling field 1600 includes a common block field with RU allocations for both the first 20 MHz channel and the third 20 MHz channel 1605 transmitted in the first eight bits of the first 20 MHz channel. A duplicate of this common block field for both the first 20 MHz channel and the third 20 MHz channel is also transmitted for in the third 20 MHz channel. RU allocations for the second 20 MHz channel and the fourth 20 MHz channel 1610 may be transmitted in the first eight (8) bits of the second 20 MHz channel. A duplicate of this common block field for both the second 20 MHz channel and the fourth 20 MHz channel is also transmitted for in the fourth 20 MHz channel. A dedicated portion 1615 of a second WLAN signaling field 1600 allocated to different users follows the common portions in each of the two 20 MHz channels.

FIG. 17A shows an example of a common block field size table 1700-a for differing bandwidth sizes in accordance with various aspects of the present disclosure. As an example, for 160 MHz, the common portion size could be 32 bits if RU allocation sizes are less than 484 tones (and HE-SIG-A bit is 0). In another example, for 160 MHz, the common portion size may be 8 bits if RU allocation sizes are all greater than or equal to 484 tones (and HE-SIG-A bit is 1). Common block field size table 1700-a shows only one possible implementation of a mapping between the values of a RU size indicator in a first WLAN signaling field (e.g., HE-SIG-A bit) and a size of a common block field in a second WLAN signaling field (e.g., of an HE-SIG-B field) for a given bandwidth.

In another example common block table, for a channel bandwidth of 80 MHz, the minimum RU for non MU-MIMO or a single user (e.g. OFDMA) allocations is 52 tones, while the MU-MIMO allocations are 242 tones. For a channel bandwidth of 160 MHz, the minimum RU for single user (e.g. OFDMA) allocations is 106 tones while the MU-MIMO allocations are 484 tones.

FIG. 17B shows an example of common block field size table 1700-b for a fixed number of tones in a RU size in accordance with various aspects of the present disclosure. In this example, for 160 MHz, the common portion size could be 32 bits if RU allocation sizes are less than 20 MHz (and HE-SIG-A bit is 0). In another example for 160 MHz, the common portion size could be 16 bits if RU allocation sizes are all greater than or equal to 242 tones (and HE-SIG-A bit is 1). Common block field size table 1700-b shows only one possible implementation of a mapping between the values of a RU size indicator in a first WLAN signaling field (e.g., HE-SIG-A bit) and a size of a common block field in a second WLAN signaling field (e.g., of an HE-SIG-B field) for a given bandwidth.

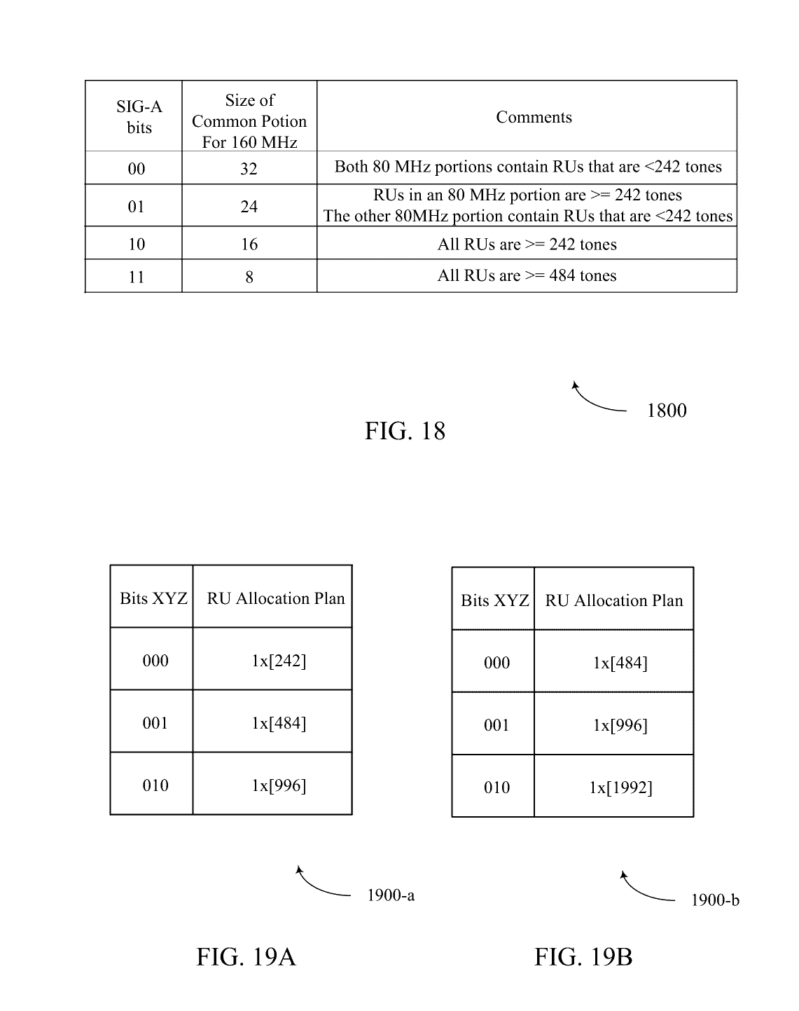

FIG. 18 shows an example of a common block field size table 1800 in accordance with various aspects of the present disclosure. In this example, two bits are used in a first WLAN signaling field (e.g., an HE-SIG-A field). A greater number RU size and common block field size combinations may be achieved for a given bandwidth where two or more bits are used in the first WLAN signaling field as an RU size indicator. More flexibility may be provided to the size of the common portion for 160 MHz PPDU bandwidth through additional bits in HE-SIG-A. Here, the RU allocation for 160 MHz is split into two 80 MHz portions. If the size of the RUs for a 80 MHz portion is greater than or equal to 242 tones, then 8 bits can be used for common portion corresponding to that 80 MHz.

In an RU allocation the size of the RUs may be less than or equal to 20 MHz, for example as described above with regard to FIGS. 1-12. This may correspond to the case when the HE-SIG-A bit is 0. When HE-SIG-A bit is 1 (assuming a single bit in the HE-SIG-A field), 8 bits may be used for both 80 MHz and 160 MHz, when the RU size for 80 MHz may be greater than or equal to 242 tones, and RU size for 160 MHz may be greater than or equal to 484 tones. Common block field size table 1800 shows only one possible implementation of a mapping between the values of RU size indicator bits (here, 2 bits) in a first WLAN signaling field (e.g., HE-SIG-A bit) and a size of a common block field in a second WLAN signaling field (e.g., of an HE-SIG-B field) for a given bandwidth.

In some examples, one or more bits of the HE-SIG-A field may indicate that the entire bandwidth to be allocated is for a single MU-MIMO transmission. In this example, a size of the HE-SIG-B field of a WLAN preamble may be reduced, for example the common block may be collapsed to have a size of zero.

FIG. 19A shows an example of an RU allocation mapping table 1900-a in accordance with various aspects of the present disclosure. For a modified RU allocation plan associated with a bandwidth of 80 MHz, a similar algorithm to the 20 MHz RU allocation scheme is followed. Possible RU allocation sizes are shown in FIG. 19A. If indicator bits are [0,0], then SU-OFDMA is used for both 20 MHz. Three (3) bits may define an allocation plan, as further discussed above with reference to FIGS. 2-11. If the RU size indicator bits are [1,0], then first 20 MHz is MU-MIMO and second 20 MHz is OFDMA. If the RU size indicator bits are [0,1], then if RU allocation is 242 tones, then first 20 MHz is SU OFDMA and second 20 MHz is MU-MIMO. And, if RU allocations are greater than 242 tones, an entire allocation may be MU-MIMO.

FIG. 19B shows an example of an RU allocation mapping table 1900-a in accordance with various aspects of the present disclosure. For a modified RU allocation plan associated with a bandwidth of 160 MHz, a similar algorithm to the 20 MHz RU allocation scheme is followed. Possible RU allocation sizes are shown in FIG. 19B. If the RU size indicator bits are [0,0], then SU-OFDMA is used for both 40 MHz and 3 bits define the allocation plan. If the RU size indicator bits are [1,0], then first 40 MHz is MU-MIMO and second 40 MHz is OFDMA. And, if the RU size indicator bits are [0,1], then, if RU allocation is 484 tones, then first 40 MHz is SU OFDMA and second 40 MHz is MU-MIMO, but if RU allocations are greater than 484 tones, the entire allocation may MU-MIMO.

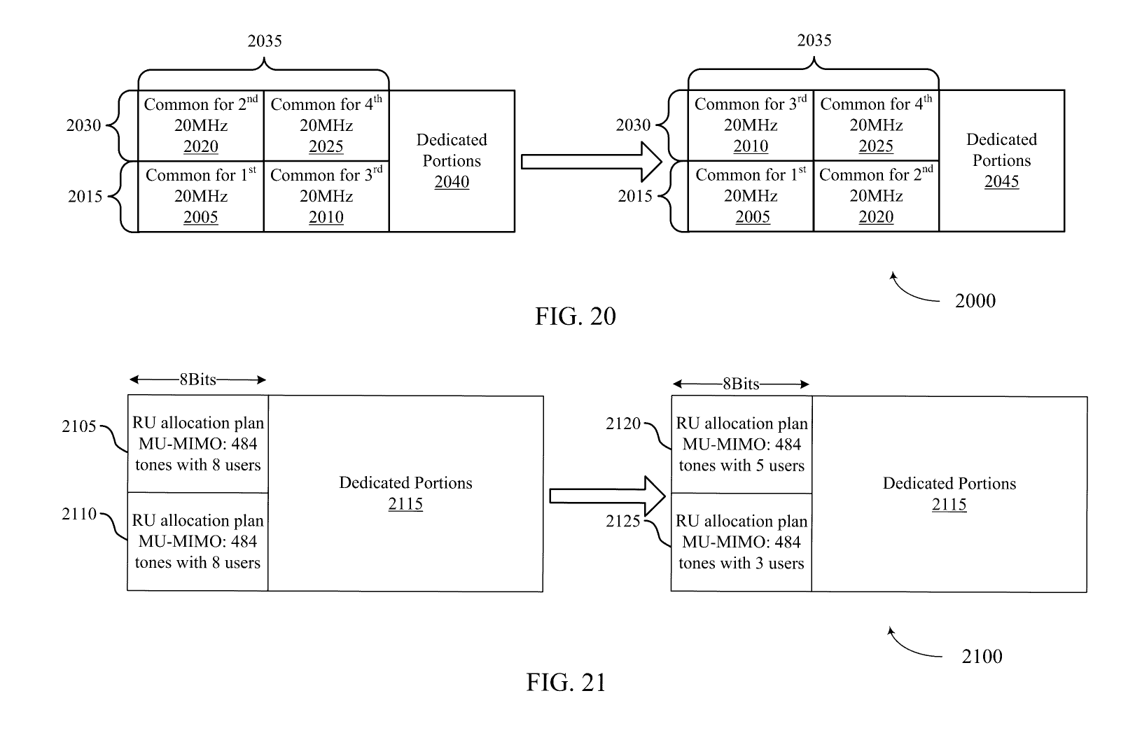

FIG. 20 shows an example of load balancing 2000 in accordance with various aspects of the present disclosure. Uneven allocations of RUs may cause loss in efficiency. For example, if the 1st and 3rd 20 MHz have 9 users each but the 2nd and 4th have only 1 user, then dedicated portions 2035 for 18 users are transmitted in the first 20 MHz 2015 but dedicated portions 2040 for only 2 users are transmitted in the 2nd 20 MHz 2030. One example for addressing this or similar situations is to remap the common block field. For example, for 80 MHz bandwidth, the 1st and 3rd 20 MHz data channels are mapped to the primary 20 MHz in HE-SIG-B. The mapping can be modified such that 1st and 2nd 20 MHz of the data channel are mapped to the primary 20 MHz of the HE-SIG-B. Load balancing, or mapping according to a load balancing, may be indicated by a bit in the first WLAN signaling field (e.g. an HE-SIG-A field).

For large MU-MIMO allocations (e.g., 484 tones or higher), the common block field and dedicated portions of the PPDU may be transmitted according to at least one of four options.

According to a first example, an allocation size and number of users is repeated in each 20 MHz.

According to a second example, an allocation size and number of users is transmitted in only one 20 MHz channel. The specific 20 MHz channel is predefined, for example to be the primary or the secondary 20 MHz channel in the PPDU

According to a third example, the allocation size is repeated but the dedicated portion is split between the 20 MHz channels of the PPDU. For example, for 8 users and 484 tones, the allocation size and number of users is repeated in each 20 MHz. A dedicated portion for 4 users may be transmitted in the first 20 MHz and the remaining 4 users may be transmitted in the second 20 MHz.

According to a fourth example, an allocation size is repeated, but the number of users in the dedicated portion is dynamic, and specifically indicated in common portion.

FIG. 21 shows an example of load balancing 2100 in accordance with various aspects of the present disclosure. Load balancing according to the fourth example described with reference to FIG. 20 is illustrated in FIG. 21. As shown in FIG. 20, rather than allocate RUs for 9 MU-MIMO users across two channels 2105 and 2110, three (3) of the MU-MIMO users are allocated RUs in a first channel 2120 and five (5) of the MU-MIMO users are allocated RUs in a second channel 2125 to balance the traffic on the channels.

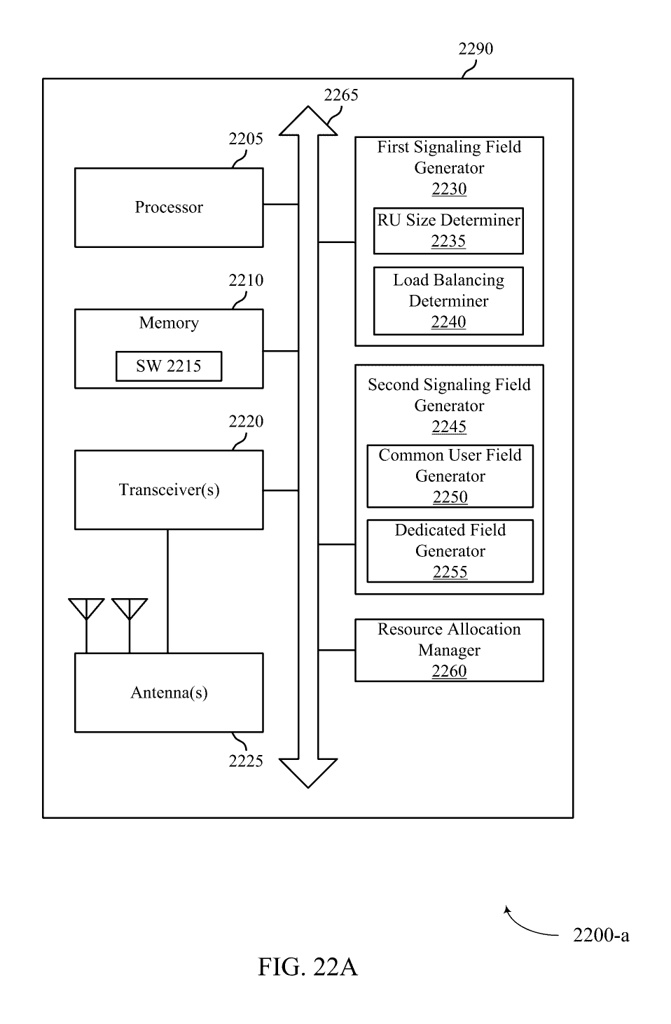

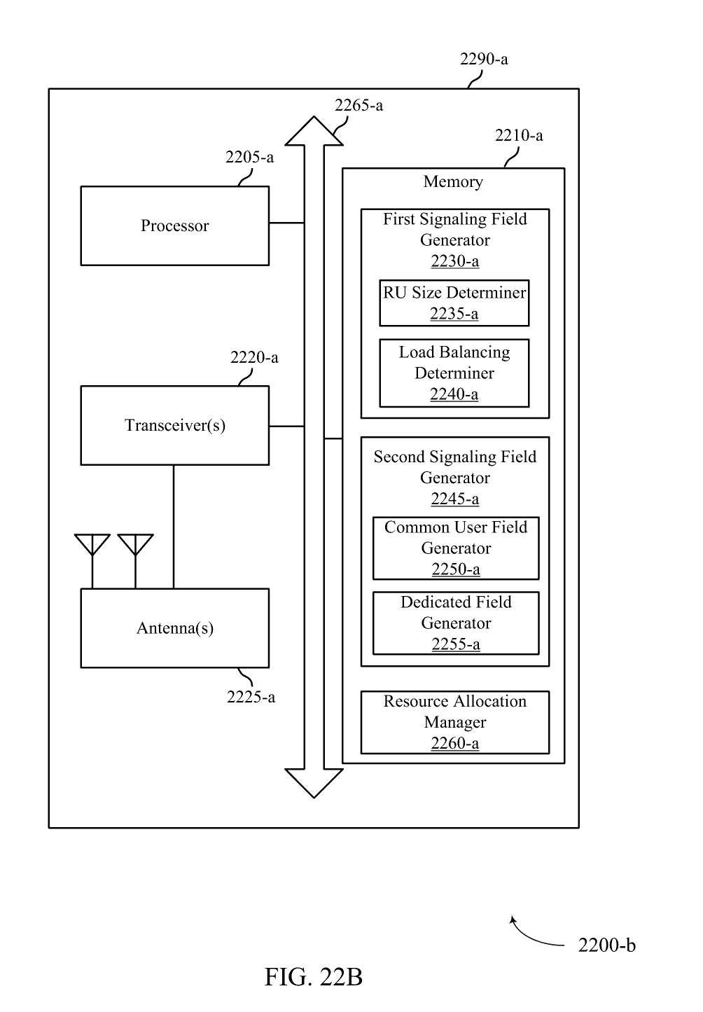

FIG. 22A shows a block diagram 2200-a of an example wireless device 2290 that supports resource allocation signaling in an HE WLAN preamble in accordance with various aspects of the present disclosure, and with respect to FIGS. 12A-21. The wireless device 2290, which may be an example of a STA 110 or an AP 105, includes a processor 2205, a memory 2210, one or more transceiver(s) 2220, one or more antenna(s) 2225, a first signaling field generator 2230, a second signaling field generator 2245, and a resource allocation manager 2260. The first signaling field generator includes a RU size determiner 2235 and a load balancing determiner 2240. The second signaling field generator 2245 includes a common user field generator 2250 and a dedicated field generator 2255. One or more of the one or more transceiver(s) 2220, first signaling field generator 2230 (including RU size determiner 2235 and load balancing determiner 2240), second signaling field generator 2245 (including common user field generator 225-0 and dedicated field generator 2255), and resource allocation manager 2260 may be implemented by a circuit or circuitry to implement one or more of the features described with reference to FIGS. 12A-21 and 23-25.

The processor 2205, memory 2210, transceiver(s) 2220, the first signaling field generator 2230, the second signaling field generator 2245, and the resource allocation manager 2260 are communicatively coupled with a bus 2265, which enables communication between these components. The antenna(s) 2225 are communicatively coupled with the transceiver(s) 2220.

The processor 2205 is an intelligent hardware device, such as a central processing unit (CPU), a microcontroller, an application-specific integrated circuit (ASIC), etc. The processor 2205 processes information received through the transceiver(s) 2220 and information to be sent to the transceiver(s) 2220 for transmission through the antenna(s) 2225.

The memory 2210 stores computer-readable, computer-executable software (SW) code 2215 containing instructions that, when executed, cause the processor 2205 or another one of the components of the wireless device 2290 to perform various functions described herein, for example, generating a RU size indicator in a first WLAN signaling field, the RU size indicator decodable by multiple stations; generating a common user field in a second WLAN signaling field, where a size of the common user field is based at least in part on the RU size indicator of the first WLAN signaling field, the common user field decodable by the multiple stations; generating, subsequent to the common user field in the second WLAN signaling field, at least one station-specific field, where a position of the at least one station-specific field corresponds to one or more RUs associated with the at least one station-specific field; and transmitting a WLAN preamble that includes the first WLAN signaling field followed by the second WLAN signaling field.

The transceiver(s) 2220 communicate bi-directionally with other wireless devices, such as APs 105, base station 150, STAs 110, or other devices. The transceiver(s) 2220 include a modem to modulate packets and frames and provide the modulated packets to the antenna(s) 2225 for transmission. The modem is additionally used to demodulate packets received from the antenna(s) 2225.

The first signaling field generator 2230, second signaling field generator 2245, and resource allocation manager 2260 implement the features described with reference to FIGS. 12A-21, as further explained below.

Again, FIG. 22A shows only one possible implementation of a device executing the features of FIGS. 12A-21. While the components of FIG. 22A are shown as discrete hardware blocks (e.g., ASICs, field programmable gate arrays (FPGAs), semi-custom integrated circuits, etc.) for purposes of clarity, it will be understood that each of the components may also be implemented by multiple hardware blocks adapted to execute some or all of the applicable features in hardware. Alternatively, features of two or more of the components of FIG. 22A may be implemented by a single, consolidated hardware block. For example, a single transceiver 2220 chip may implement the processor 2205, memory 2210, first signaling field generator 2230, second signaling field generator 2245, and resource allocation manager 2260.

In still other examples, the features of each component may also be implemented, in whole or in part, with instructions embodied in a memory, formatted to be executed by one or more general or application-specific processors. For example, FIG. 22B shows a block diagram 2200-b of another example of a wireless device 2290-a in which the features of the first signaling field generator 2230-a, the second signaling field generator 2245-a, and the resource allocation manager 2260-a are implemented as computer-readable code stored on memory 2210-a and executed by one or more processor 2205-a. Other combinations of hardware/software may be used to perform the features of one or more of the components of FIGS. 22A-22B.

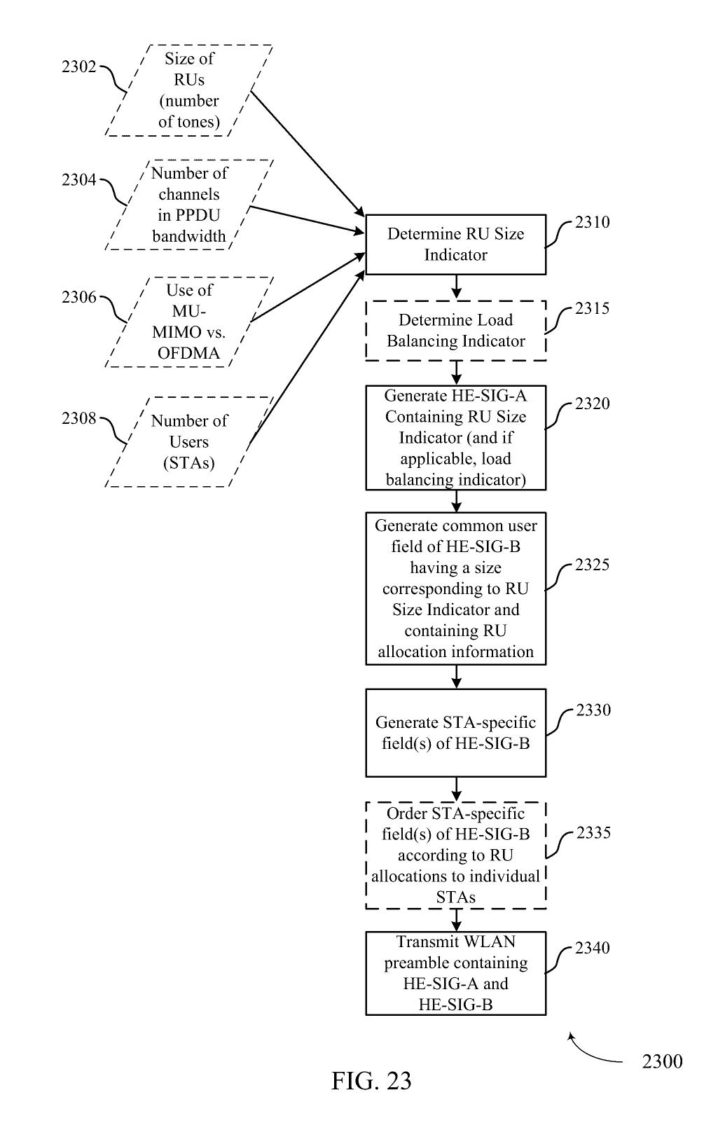

FIG. 23 shows a flow chart that illustrates one example of a method 2300 for wireless communication, in accordance with various aspects of the present disclosure. The method 2300 can be performed by any of the wireless device 2290, AP 105, or STA 110 discussed in the present disclosure, but for clarity the method 2300 will be described from the perspective of wireless device 2290 and wireless device 2290-a, of FIGS. 22A and 22B.

Broadly speaking, the method 2300 illustrates a procedure by which the wireless device 2290 generates an RU size indicator in a first WLAN signaling field, a common user field in a second WLAN signaling field, and at least one station-specific field in the second WLAN signaling field, wherein the RU size indicator and the common user field are decodable by a plurality of stations, wherein a size of the common user field is based at least in part on the RU size indicator, and wherein the at least one station-specific field corresponds to one or more RUs associated with the at least one station-specific field and transmits a WLAN preamble that includes the first WLAN signaling field followed by the second WLAN signaling field.

At 2310, the RU size determiner 2235 of the first signaling field generator 2230 determines an RU size for an allocation of wireless resources for a PPDU. The RU size can be determined based at least in part on the minimum size 2302 (e.g. number of tones) in an RU allocation for the PPDU, the number of channels 2304 in the PPDU bandwidth, a determination 2306 of whether MU-MIMO, OFDMA, or both are to be used for the PPDU, and/or a number of users (e.g. STAs) 2308 associated with the PPDU. The RU size indicator can be one or more bits included in the HE-SIG-A portion of a WLAN preamble signaling the composition and organization of the common portions of the HE-SIG-B portion of the WLAN preamble, as discussed above.

At 2315, the load balancing determiner 2240 of the first signaling field generator 2230 and the resource allocation manager 2260 determine whether load balancing is to be used to remap the common portions of a HE-SIG-B portion of a preamble for the PPDU. For example, if different 20 MHz channels have different numbers of users, dedicated load balancing may remap the common portions of HE-SIG-B to balance out the number of users, as discussed with reference to FIG. 20. The load balancing indicator can be one or more bits indicating whether load balancing is used in the HE-SIG-B signaling field of a WLAN preamble.

At 2320, the first signaling field generator 2230 generates an HE-SIG-A signaling field of the WLAN preamble. The HE-SIG-A signaling field includes the RU size indicator and (optionally) the load balancing indicator.

At 2325, the common user field generator 2250 of the second signaling field generator 2245 generates the common user field of the HE-SIG-B signaling field of the WLAN preamble. The size of the common user field corresponds to the RU size indicator signaled in the HE-SIG-B signaling field of the WLAN preamble, as discussed with reference to blocks 2310 and 2320. The common user field of the HE-SIG-B signaling field includes RU allocation information for one or more users scheduled for the PPDU.

At 2330, the dedicated field generator 2255 generates the STA-specific field(s) of the HE-SIG-B signaling field of the WLAN preamble. These STA-specific field(s) include control information specific to each scheduled user (e.g. STA) to enable the user to decode the data (e.g., MCS, coding, spatial multiplexing, and other control information).

At 2335, the dedicated field generator 2255 can optionally order the STA-specific fields of the HE-SIG-B signaling field of the WLAN preamble according to RU allocations to individual STAs, as discussed above.

At block 2340, the transceiver(s) 2240 transmits the WLAN preamble containing the generated HE-SIG-A and HE-SIG-B signaling fields. Following the WLAN preamble, the transceiver(s) 2240 send the PPDU.

Though method 2300 describes and/or illustrates an order or sequence, the order or sequence may be different, and certain steps or actions, or groups of steps or actions, may be performed together or in parallel. For example, the features of block 2320, block 2325, and block 2330 may occur together, such that the first signaling field generator 2230 generates an HE-SIG-A signaling field of the WLAN preamble, the common user field generator 2250 of the second signaling field generator 2245 generates the common user field of the HE-SIG-B signaling field, and the dedicated field generator 2255 generates the STA-specific field(s) of the HE-SIG-B signaling field of the WLAN preamble at the same time or in parallel. In other examples, the entirety of the WLAN preamble may be generated together, or each of the HE-SIG-A signaling field and the HE-SIG-B field may be generated together.

Generating a field, an indication in a field, or bits of a field, as used herein, including for example at 2320, at 2325, and/or at 2330, may include generating or providing bits to be included in the respective signaling fields, storing bits associated with the field or indicator in registers or memory, providing signaling or instructions to a device to provide such bits, or otherwise cause the communication of signaling or bit values representative of a signaling field or a portion of a signaling field.

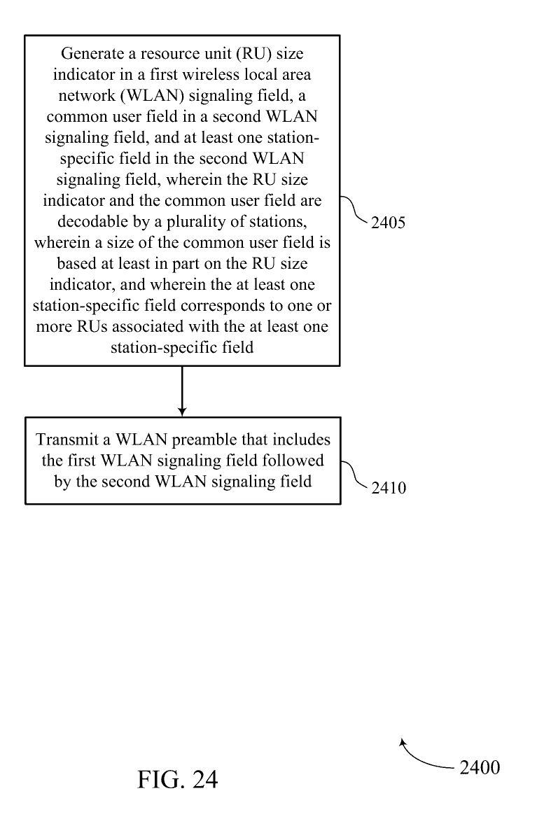

FIG. 24 shows a flowchart illustrating a method 2400 for wireless communication, in accordance with various aspects of the present disclosure. The operations of method 2400 may be implemented by an AP 105 or its components as described herein. In some examples, an AP 105 may execute a set of codes to control the functional elements of the device to perform the functions described below. Additionally or alternatively, the AP 105 may perform aspects of the functions described below using special-purpose hardware.

At block 2405, the AP 105 may generate a RU size indicator in a first WLAN signaling field, a common user field in a second WLAN signaling field, and at least one station-specific field in the second WLAN signaling field, wherein the RU size indicator and the common user field are decodable by a plurality of stations, wherein a size of the common user field is based at least in part on the RU size indicator, and wherein the at least one station-specific field corresponds to one or more RUs associated with the at least one station-specific field. The operations of block 2405 may be performed according to the methods described with reference to FIG. 23. In certain examples, aspects of the operation of block 2405 may be performed by RU size determiner 2235, common user field generator 2250, and/or dedicated field generator 2255 as described herein with reference to FIGS. 22A-B. The common user field may be a common station field, and may be decodable by one or more stations or other wireless devices receiving the common user field or common station field. Generating a field or an indicator in a field, or bits of a field, as used herein, including with reference to block 2405, may include generating or providing bits to be included in the respective first or second WLAN signaling fields, or storing bits associated with the field or indicator in registers or memory, providing signaling or instructions to a device to provide such bits, or otherwise cause the communication of signaling or bit values representative of the first or second WLAN signaling fields or a portion of such fields. Though method 2400 describes and/or illustrates generating the RU size indicator, common user field, and at least one station-specific field in block 2405, the order or sequence for generating the RU size indicator, common user field, and at least one station-specific field may be different, at different time, or performed by different devices or circuitry. Certain steps or actions, or groups of steps or actions, of the generating may be performed together, in groups, or separately, sequentially or in parallel.

At block 2410, the AP 105 may transmit a WLAN preamble that includes the first WLAN signaling field followed by the second WLAN signaling field. The operations of block 2410 may be performed according to the methods described with reference to FIG. 23. In certain examples, aspects of the operation of block 2410 may be performed by a transceiver 2220 and/or antenna 2225 as described herein with reference to FIGS. 22A-B.

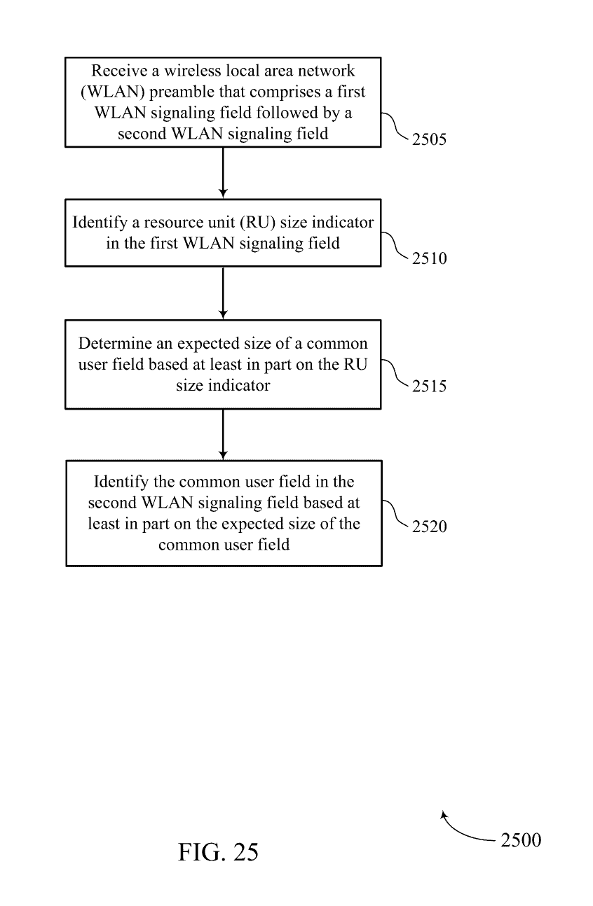

FIG. 25 shows a flowchart illustrating a method 2500 for wireless communication, in accordance with various aspects of the present disclosure. The operations of method 2500 may be implemented by a STA 110 or its components as described herein. In some examples, a STA 110 may execute a set of codes to control the functional elements of the device to perform the functions described below. Additionally or alternatively, the STA 110 may perform aspects of the functions described below using special-purpose hardware.

At block 2505, the STA 110 may receive a WLAN preamble that comprises a first WLAN signaling field followed by a second WLAN signaling field. At block 2510, the STA 110 may identify a resource unit RU size indicator in the first WLAN signaling field. At block 2515, the STA 110 may determine an expected size of a common user field based at least in part on the RU size indicator. At block 2520, the STA 110 may identify the common user field in the second WLAN signaling field based at least in part on the expected size of the common user field.

The detailed description set forth above in connection with the appended drawings describes examples and does not represent the only examples that may be implemented or that are within the scope of the claims. The terms “example” and “exemplary,” when used in this description, mean “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and apparatuses are shown in block diagram form in order to avoid obscuring the concepts of the described examples.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a digital signal processor (DSP), an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope and spirit of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. As used herein, including in the claims, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination. Also, as used herein, including in the claims, “or” as used in a list of items (for example, a list of items prefaced by a phrase such as “at least one of” or “one or more of”) indicates a disjunctive list such that, for example, a list of “at least one of A, B, or C” means A or B or C or AB or AC or BC or ABC (i.e., A and B and C).

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, flash memory, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not to be limited to the examples and designs described herein but is to be accorded the broadest scope consistent with the principles and novel features disclosed herein.

What is claimed is:

1. An apparatus for wireless communication, comprising:
a memory that stores instructions; and
a processor coupled with the memory, wherein the processor and the memory are configured to:
generate a resource unit (RU) size indicator in a first wireless local area network (WLAN) signaling field, the RU size indicator decodable by a plurality of stations;
generate a common user field in a second WLAN signaling field,
wherein a size of the common user field is based at least in part on the RU size indicator of the first WLAN signaling field, the common user field decodable by the plurality of stations;
generate at least one station-specific field in the second WLAN signaling field, wherein the at least one station-specific field corresponds to one or more RUs associated with the at least one station-specific field; and
transmit a WLAN preamble that includes the first WLAN signaling field followed by the second WLAN signaling field.

2. The apparatus of claim 1, wherein the processor and the memory are further configured to:
determine the size of the common user field based at least in part on a bandwidth associated with the common user field and the RU size indicator, wherein the RU size indicator indicates a parameter selected from a group consisting of: a number of tones in a RU, a bandwidth of the common user field, and a number of user devices.

3. The apparatus of claim 1, wherein the processor and the memory are further configured to:
determine the size of the common user field based at least in part on a bandwidth associated with the common user field and the RU size indicator, wherein the RU size indicator indicates that one or more RU allocation plans in a multi-user (MU) physical layer protocol data unit (PPDU) (MU-PPDU) are associated with an multi-user multi-input multi-output (MU-MIMO) transmission or an orthogonal frequency division multiple access (OFDMA) single-user transmission.

4. The apparatus of claim 1, wherein:
the at least one station-specific field comprises a first station-specific field and a second station-specific field;
the one or more RUs comprise a first RU associated with the first station-specific field and a second RU associated with the second station-specific field; and
generating the at least one station-specific field comprises determining a position of the first station-specific field with respect to a position of the second station-specific field based at least in part on a position of the first RU with respect to the second RU.

5. The apparatus of claim 1, wherein:
the RU size indicator comprises a plurality of bits; and
the processor and the memory are further configured to:
split a total bandwidth for the plurality of stations into a plurality of portions for independent RU allocation; and
determine the size of the common user field based at least in part on the plurality of bits and an RU size associated with at least one of the portions.

6. The apparatus of claim 1, wherein:
the RU size indicator comprises a plurality of bits that indicate that the one or more RUs associated with the at least one station-specific field are associated with a multi-user (MU) multi-input multi-output (MU-MIMO) transmission or an orthogonal frequency division multiple access (OFDMA) single-user transmission or a combination of MU-MIMO and OFDMA transmissions; and
an RU allocation plan depends at least in part on the plurality of bits.

7. The apparatus of claim 1, wherein the processor and the memory are further configured to:
generate a load balancing indicator in the first WLAN signaling field, wherein the load balancing indicator indicates a remapping of an order of bits in the common user field.

8. The apparatus of claim 1, wherein the processor and the memory are further configured to:
identify that the one or more RUs are associated with a multi-user multi-input multi-output (MU-MIMO) transmission;
map a first RU allocation plan associated with a first one or more user devices to a first channel; and
map a second RU allocation plan associated with a second one or more user devices to a second channel.

9. The apparatus of claim 8, wherein a difference between a count of the first one or more user devices is one or fewer than a count of the second one or more user devices.

10. The apparatus of claim 1, wherein:
the common user field comprises a resource allocation field indicating one or more communication resource units in a multi-user (MU) physical layer protocol data unit (PPDU) (MU-PPDU);
the first WLAN signaling field comprises a high efficiency signaling A (HE-SIG-A) field; and
the second WLAN signaling field comprises a high efficiency signaling B (HE-SIG-B) field.

11. A method of communication at an access point, comprising:
generating a resource unit (RU) size indicator in a first wireless local area network (WLAN) signaling field, a common user field in a second WLAN signaling field, and at least one station-specific field in the second WLAN signaling field, wherein the RU size indicator and the common user field are decodable by a plurality of stations, wherein a size of the common user field is based at least in part on the RU size indicator, and wherein the at least one station-specific field corresponds to one or more RUs associated with the at least one station-specific field; and
transmitting a WLAN preamble that includes the first WLAN signaling field followed by the second WLAN signaling field.

12. The method of claim 11, further comprising:
determining the size of the common user field based at least in part on a bandwidth associated with the common user field and the RU size indicator, wherein the RU size indicator indicates a parameter selected from a group consisting of: a number of tones in a RU, a bandwidth of the common user field, and a number of user devices.

13. The method of claim 11, further comprising:
determining the size of the common user field based at least in part on a bandwidth associated with the common user field and the RU size indicator, wherein the RU size indicator indicates that one or more RU allocation plans in a multi-user (MU) physical layer protocol data unit (PPDU) (MU-PPDU) are associated with an multi-user multi-input multi-output (MU-MIMO) transmission or an orthogonal frequency division multiple access (OFDMA) single-user transmission.

14. The method of claim 11, wherein:
the at least one station-specific field comprises a first station-specific field and a second station-specific field;
the one or more RUs comprise a first RU associated with the first station-specific field and a second RU associated with the second station-specific field; and
generating the at least one station-specific field comprises determining a position of the first station-specific field with respect to a position of the second station-specific field based at least in part on a position of the first RU with respect to the second RU.

15. The method of claim 11, wherein the RU size indicator comprises and plurality of bits, the method further comprising:
splitting a total bandwidth for the plurality of stations into a plurality of portions for independent RU allocation; and
determining the size of the common user field based at least in part on the plurality of bits and an RU size associated with at least one of the portions.

16. The method of claim 11, wherein:
the RU size indicator comprises a plurality of bits that indicate that the one or more RUs associated with the at least one station-specific field are associated with an MU multi-input multi-output (MIMO) transmission or an orthogonal frequency division multiple access (OFDMA) single-user transmission or a combination of MU MIMO and OFDMA transmissions; and
an RU allocation plan depends at least in part on the plurality of bits.

17. The method of claim 11, further comprising:
generating a load balancing indicator in the first WLAN signaling field, wherein the load balancing indicator indicates a remapping of an order of bits in the common user field.

18. The method of claim 11, further comprising:
identifying that the one or more RUs are associated with a multi-user multi-input multi-output (MU-MIMO) transmission;
mapping a first RU allocation plan associated with a first one or more user devices to a first channel; and
mapping a second RU allocation plan associated with a second one or more user devices to a second channel.

19. The method of claim 18, wherein a difference between a count of the first one or more user devices is one or fewer than a count of the second one or more user devices.

20. The method of claim 11, wherein:
the common user field comprises a resource allocation field indicating one or more communication resource units in a multi-user (MU) physical layer protocol data unit (PPDU) (MU-PPDU);
the first WLAN signaling field comprises a high efficiency signaling A (HE-SIG-A) field; and
the second WLAN signaling field comprises a high efficiency signaling B (HE-SIG-B) field.

21. An apparatus for wireless communication at a station, comprising:
a memory that stores instructions; and
a processor coupled with the memory, wherein the processor and the memory are configured to:
receive a wireless local area network (WLAN) preamble that comprises a first WLAN signaling field followed by a second WLAN signaling field;
identify a resource unit (RU) size indicator in the first WLAN signaling field;
determine an expected size of a common user field based at least in part on the RU size indicator; and
identify the common user field in the second WLAN signaling field based at least in part on the expected size of the common user field.

22. The apparatus of claim 21, wherein the apparatus is a wireless communication terminal and further comprises an antenna and a transceiver.

23. The apparatus of claim 21, wherein the RU size indicator indicates that one or more RU allocation plans in a multi-user (MU) physical layer protocol data unit (PPDU) (MU-PPDU) are associated with a multi-user multi-input multi-output (MU-MIMO) transmission or an orthogonal frequency division multiple access (OFDMA) single-user transmission.

24. The apparatus of claim 21, wherein the RU size indicator comprises a plurality of bits that indicate that the one or more RUs associated with the at least one station-specific field are associated with an MU multi-input multi-output (MIMO) transmission or an orthogonal frequency division multiple access (OFDMA) single-user transmission or a combination of MU MIMO and OFDMA transmissions.

25. The apparatus of claim 21, wherein the processor and the memory are further configured to:
identify a load balancing indicator in the first WLAN signaling field; and
determine an order of bits in the common user field based at least in part on the identified load balancing indicator.

26. The apparatus of claim 21, wherein:
the common user field comprises a resource allocation field indicating one or more communication resource units in a multi-user (MU) physical layer protocol data unit (PPDU) (MU-PPDU);
the first WLAN signaling field comprises a high efficiency signaling A (HE-SIG-A) field; and
the second WLAN signaling field comprises a high efficiency signaling B (HE-SIG-B) field.

27. A method of communication at a station, comprising:
receiving a wireless local area network (WLAN) preamble that comprises a first WLAN signaling field followed by a second WLAN signaling field;
identifying a resource unit (RU) size indicator in the first WLAN signaling field;
determining an expected size of a common user field based at least in part on the RU size indicator; and
identifying the common user field in the second WLAN signaling field based at least in part on the expected size of the common user field.

28. The method of claim 27, wherein the RU size indicator indicates that one or more RU allocation plans in a multi-user (MU) physical layer protocol data unit (PPDU) (MU-PPDU) are associated with a multi-user multi-input multi-output (MU-MIMO) transmission or an orthogonal frequency division multiple access (OFDMA) single-user transmission.

29. The method of claim 27, wherein the RU size indicator comprises a plurality of bits that indicate that the one or more RUs associated with the at least one station-specific field are associated with an MU multi-input multi-output (MIMO) transmission or an orthogonal frequency division multiple access (OFDMA) single-user transmission or a combination of MU MIMO and OFDMA transmissions.

30. The method of claim 27, further comprising:
identifying a load balancing indicator in the first WLAN signaling field; and
determining an order of bits in the common user field based at least in part on the identified load balancing indicator.
